(19) United States
(12) Patent Application Publication
(10) Pub. No.: US 2026/0105395 A1
(43) Pub. Date: Apr. 16, 2026

(54) WORKFLOW AUTOMATION

(71) Applicant: ServiceNow, Inc., Santa Clara, CA (US)

(72) Inventors: Jing Fei Chen, San Francisco, CA (US); Orlando Edson Marquez Ayala, Montreal (CA); Jennifer Lyons, San Diego, CA (US); Patrice Bechard, Montreal (CA)

(21) Appl. No.: 18/911,959

(22) Filed: Oct. 10, 2024

(51) Int. Cl. G06Q 10/0633; G06F 40/205

(52) U.S. Cl. CPC G06Q 10/0633; G06F 40/205

(57) ABSTRACT

Systems and techniques are provided for automating workflows on a workflow automation platform. An example method can include receiving an input prompt representing a request to generate a flow in a workflow automation platform, wherein the input prompt includes a description of the flow and the description of the flow includes a linkage between a metadata tag and a data structure; identifying, based on the linkage, data associated with the flow; determining a set of components of the flow based on the description of the flow and the data associated with the flow, the set of components of the flow including a flow trigger and a flow action; and based on the set of components of the flow, generating the flow in the workflow automation platform, the generated flow including executable instructions configured to trigger the flow action in response to a detection of the flow trigger.

### BACKGROUND

### 1. Technical Field

The present disclosure generally relates to workflow automation and, more specifically, to automatically generating flows based on input prompts.

### 2. Introduction

Entities such as business enterprises and other organizations often use workflow platforms to manage the flow of tasks and data based on business rules, needs, and/or constraints. The workflow platforms can include software used to create and execute flows used by the entities to accomplish respective goals. The flows can include specific sequences or series of tasks, processes, and/or actions performed to accomplish respective goals. For example, a flow can include a trigger(s) and an action(s), and can optionally include flow logic. The trigger(s) can define when to initiate the action(s), and the action(s) can include any task, function, operation, step, and/or process to implement for the flow. However, the process of automating flows for entities can be difficult, as a flow and even the characteristics of an accurate flow can vary based on various factors. In some examples, the intended meaning of terms in inputs used to create flows can vary based on context, which can impact the accuracy and/or quality of flows generated from the inputs. The accuracy and/or quality of a flow generated based on an input can also depend on the data provided in the input. Evaluating flows generated by a workflow platform for quality and accuracy can also be difficult and complex as the criteria for evaluating flows can vary.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing environment that can be used to implement a workflow automation platform, according to some examples of the present disclosure;

FIG. 1B is a block diagram illustrating an example network architecture that can be used to implement the example cloud computing environment shown in FIG. 1A, according to some examples of the present disclosure;

FIG. 2 is a diagram illustrating an example system process for generating flows based on user inputs including metadata tags, according to some examples of the present disclosure;

FIGS. 3A and 3B are diagrams illustrating example configurations of an interface for providing an input prompt used to generate a flow in a workflow automation platform, according to some examples of the present disclosure;

FIG. 4 is a diagram illustrating an example of an interface depicting a representation of an example input prompt and an example outline of a flow generated based on the input prompt, according to some examples of the present disclosure;

FIG. 5 is a diagram illustrating an example rendering of a flow generated by a workflow automation platform based on an input prompt, according to some examples of the present disclosure;

FIG. 6 is a diagram illustrating an example system process for evaluating flows generated by different versions of software of a workflow automation platform, according to some examples of the present disclosure;

FIG. 7 is a diagram illustrating an example scoring rubric that a flow evaluation engine can use to evaluate flows from software model versions of a workflow automation platform, according to some examples of the present disclosure;

FIG. 8 is a flowchart illustrating an example method for generating flows in a workflow automation platform based on input prompts, according to some examples of the present disclosure;

FIG. 9 is an example of a deep learning neural network that can be used to implement all or a portion of the systems and techniques described herein, according to some examples of the present disclosure;

FIG. 10 is a diagram illustrating an example architecture of an example transformer model, according to some examples of the present disclosure; and

FIG. 11 illustrates an example processor-based system that can implement any features of the subject technology, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As previously explained, entities such as business enterprises and other organizations may use workflow automation platforms to autonomously manage the flow of tasks and data based on business rules, needs, and/or constraints. The workflow automation platforms can streamline processes, reduce manual work, and enhance operational efficiency. The workflow automation platforms can include software used to automatically create and execute flows used by the entities to accomplish respective goals. The flows can include specific sequences or series of tasks, processes, and/or actions performed to accomplish respective goals. For example, a flow can include a trigger(s) and an action(s), and can optionally include flow logic. The trigger(s) can define when to initiate the action(s), and the action(s) can include any task, function, operation, step, and/or process to implement for the flow. Moreover, the flow logic can include branching logic, which can define any conditions used to execute conditional actions and/or repeated actions.

The workflow automation platforms can automatically create flows based on user inputs and/or any other data. In some examples, a workflow automation platform can automatically create flows based on text inputs such as text prompts from users, which can greatly simplify the flow generation process for the users and reduce manual work. However, the process of automating flows for entities can be difficult, as a flow and even the characteristics of an accurate flow can vary based on various factors. For example, a flow and the characteristics of an accurate flow can vary by entity, department, system environment, desired outcome, user intent, or any other context information.

Moreover, the intended meaning of terms in inputs used to create flows can also vary based on context. For example, for a first entity, the terms “financial request” included in a text input (e.g., a text prompt) used to create a flow can mean or refer to a table named “financial request” in an environment of the first entity. On the other hand, for a second entity, the terms “financial request” in the text prompt may mean or refer to a request named “financial request”, and for a third entity may more generally mean or refer to a request for financial information. Thus, the meaning of the same term in an input can vary for different entities given a context associated with each entity, such as the environment of each entity (e.g., the business, data, and/or network environment), the terminology used by each entity, the business or field of each entity, the geographic region of each entity, a domain of each entity, the business practices and procedures of each entity, the context in which the term is used, and/or any other context information. If the intended meaning of a term in an input used to create a flow is not accurately recognized or interpreted by the workflow automation platform given a relevant context, the input may result in a lower quality and/or less accurate flow.

For example, as illustrated above, the meaning of data (e.g., terms and/or other data) in inputs (e.g., text inputs and/or any other inputs) used to create flows can have entity-based and/or context-based variations. The entity-based and/or context-based variations in the meaning of the data in the inputs can increase the difficulty of accurately interpreting the data and translating the inputs into flows, and may increase the likelihood of misinterpreting the data in the inputs. Consequently, any entity-based and/or context-based variations in the meaning of data in an input used to create a flow can impact the quality and accuracy of the flow. To illustrate, if any entity-based and/or context-based variations in the meaning of a specific term in an input used to create a flow result in an interpretation error or inaccuracy of the specific term (and/or the input including the specific term), the interpretation error or inaccuracy can negatively impact the quality and accuracy of the flow generated from that input.

In addition, the accuracy and/or quality of a flow generated based on an input from a user can depend on the data provided by the user in an input used to generate the flow. For example, the accuracy and/or quality of a flow generated based on a text input from a user can depend on the precision, specificity, and clarity of the text input provided by the user. If the text input provided by the user includes vague, unclear, imprecise, and/or incomplete information, the text input may result in a less accurate and/or lower quality flow than a flow generated from a text input that includes more precise, specific, clear, and/or complete information. Thus, the quality and/or accuracy of flows generated by a workflow automation platform based on inputs from users can depend on the ability of the users to provide clear, precise, specific, and complete information in the inputs. In many cases, when a workflow automation platform receives a user input to create a flow, the workflow automation platform may need additional information to accurately interpret the user input and generate an accurate and useful flow associated with the user input.

Evaluating flows generated by a workflow automation platform for quality and accuracy can also be very difficult as the criteria for evaluating flows can vary, which increases the difficulty and complexity of evaluating the flows. For example, as previously explained, different entities may have different criteria for assessing the quality of flows, at least in part because the flows can be context-dependent and may be implemented in different environments with different systems, settings, rules, parameters, and/or any other environment components or attributes. Moreover, there are often entity-based and/or context-based variations in the meaning of data included in the inputs used to generate flows, which can also increase the complexity of evaluating flows generated for any given entity.

In some cases, even within a same environment and/or entity, different users may have different criteria for assessing the quality of flows given their respective preferences, experiences, domain knowledge, levels of subject familiarity, etc. Indeed, even the information (e.g., language, data, etc.) used by different users to formulate inputs (and/or the manner for formulating the inputs) for generating flows can also vary. For example, a user in an entity may prefer to use a different input than a different user to achieve for the same purpose. To illustrate, an information technology service management (ITSM) developer in an entity may prefer to use a spoken input stating “add worknote to incident” or “update assignee” to generate an action for a flow to update a record, while a general platform administrator may prefer to use the input “update record” to achieve the same result.

In some examples, the criteria for assessing the quality of flows can also vary for different types and/or styles of inputs used to generate the flows, such as different types and/or styles of prompts. The criteria for assessing the quality of flows can also vary for different types of flows and/or different parts of flows. If a flow needs to support integration in a third-party environment, different third-party entities may have different integration patterns that may need to be considered or followed by the workflow automation platform, which increases the flow generation and evaluation complexity.

Described herein are systems, apparatuses, processes (also referred to as methods), and computer-readable media (collectively referred to as “systems and techniques”) for easily and seamlessly adding relevant information to user inputs used to automatically generate flows. In some examples, the user inputs can provide relevant information for associated flows by including metadata tags, such as hashtags, in the user inputs. The metadata tags can link any terms within the metadata tags to data structures containing relevant information, such as context information and/or other information. The data structures can include any data structures used to store, encode, and/or encapsulate data such as, for example and without limitation, database tables, database records, database fields, object instances (e.g., instances of an object encapsulating data and associated actions such as objects in object-oriented databases, instances of any other data object), data wrappers or containers, data stores, data files, file systems, files, folders, data containers, data drives, server shares, disk volumes, logical volumes or drives, data wrappers, and/or any other data structures.

In some cases, the systems and techniques described herein can use an artificial intelligence (AI) model, such as a large language model (LLM), to parse user inputs provided for generating flows in order to identify any metadata tags in the user inputs. The AI model can use the metadata tags in the user inputs to identify associated data structures, query associated data structures, and retrieve information from the associated data structures. The retrieved information can include any information that can help the AI model interpret language (e.g., terms) in the user inputs and account for any interpretation issues and/or variations, such as entity-based and/or context-based variations in the meaning of terms used in user inputs used to generate the flows. The AI model can thus use the retrieved information to accurately translate the user inputs into flows generated from the user inputs. For example, the AI model can use the retrieved information to interpret natural language in the user inputs to better understand the user inputs and generate the flows.

The information obtained using the metadata tags can include any information from the data structures associated with the metadata tags, and in any amount/volume. For example, the information retrieved from the data structures based on the metadata tags can include any information that is relevant to the flow (and/or to generating the flow) such as, for example and without limitation, context information, supplemental or auxiliary information, and/or any other additional/relevant information that can help the AI model understand the user inputs and generate accurate and/or customized flows, even if the user inputs are otherwise vague, imprecise, lack useful details, and/or otherwise lower quality. Moreover, the information retrieved from the data structures based on the metadata tags in the user inputs can help the AI model generate the flows.

In some implementations, the AI model can use the user inputs and the information retrieved from the data structures to identify the components of the flows, which the AI model can use to generate the flows. The components of a flow can include, for example, one or more triggers used to initiate the flow and one or more actions executed in response to detecting the one or more triggers. In some cases, the components of the flow can additionally include flow logic, such as branching logic, used to execute the one or more actions. For example, the flow logic can include one or more conditions used to execute one or more conditional and/or repeated actions, such as If statements, Else statements, Else If statements, loops (e.g., For Each, Do the following until, Do the following in Parallel, etc.), While statements, utility logic (e.g., Wait for a duration of time logic used to pause a flow, Call a Workflow logic to execute a particular workflow, End logic to end flow processing within a logic branch, Dynamic Flow to execute a flow or subflow dynamically, Get Flow Outputs to obtain outputs from an embedded flow, Set Flow Variables to set variables for a flow, etc.), and/or any other logic.

The AI model can use the components of the flow to automatically generate the flow (and, optionally, any subflows). For example, the AI model can use the components of the flow to generate a trigger(s) for the flow, an action(s) to execute in response to the trigger(s), and optionally any flow logic. In some cases, the flow can include executable instructions configured to trigger a flow action(s) responsive to a flow trigger(s), according to associated flow logic (if any). Moreover, a flow generated by the AI model can optionally include one or more subflows, which can include one or more respective triggers, one or more respective actions, and can optionally include any flow logic.

The AI model can include any AI or machine learning (ML) model, such as an LLM. The AI model can implement a single AI/ML model or multiple AI/ML models. In some examples, the AI model can implement one or more neural networks, one or more neural network heads, one or more neural network branches, one or more neural network cores, one or more neural network interfaces (e.g., application-specific interfaces (APIs), etc.), and/or any other components. Each of the one or more neural networks can include any neural network type/architecture such as, for example and without limitation, a transformer network, a convolutional neural network, an autoencoder network, a sequence-to-sequence network, a recurrent neural network, a long short-term memory network, a mixture-of-experts network, an encoder and/or decoder network (e.g., encoder-decoder network, encoder-only network, decoder-only network, etc.), and/or any other artificial and/or deep learning neural network.

In some examples, the AI model can generate a visual representation of a flow as it generates the flow, which can be presented on a display for a user to view the flow as it is generated. For example, the AI model can generate or render a visual representation of the flow and add details to the visual representation of the flow as the flow is generated. In some aspects, as the AI model generates a flow, the AI model can first generate or render an outline of the flow. The outline of the flow can depict a visual representation of a flow trigger(s), a visual representation of a flow action(s), a visual representation of any flow logic and/or conditions, and a visual representation of interdependencies between the flow trigger(s), the flow action(s), and any flow logic and/or conditions. As the AI model determines any other details of the flow trigger(s), the flow action(s), and any flow logic and/or conditions, the AI model can add the details of the flow trigger(s) to visual representation of the flow trigger(s), the details of the flow action(s) to the visual representation of the flow action(s), and any details of any flow logic and/or conditions to any visual representation of the flow logic and/or conditions. This way, the user can visualize the flow as the flow is generated. In some cases, the AI model can render interface elements that the user can use to pause the generation of the flow and/or make changes to the flow as the flow is generated.

The systems and techniques described herein can also provide strategies and tools for evaluating flows generated by an AI model. For example, the systems and techniques described herein can provide a software tool used to score flows and/or inputs used to generate flows. The scores can be based on a scoring matrix or rubric that accounts for various factors such as, for example and without limitation, vagueness/specificity scores for the inputs, usefulness and/or quality scores for the flows, creativity scores for the flows, accuracy scores for the flows, anomality scores for the flows, scores indicating whether the flows include an terms classified or predefined as undesirable or prohibited, and/or any other scores. In some cases, the software tool can use the scores for multiple flows from a version of the AI model to determine a performance of that version of the AI model. In some examples, the software tool can use scores determined for sets of flows generated by different versions of the AI model to determine a performance of each version of the AI model. In some aspects, the software tool can compare the performance of the different versions of the AI model to test the different versions of the AI model. For example, the software tool can use the flow scores from the different versions of the AI model to perform A/B testing of the different versions of the AI model.

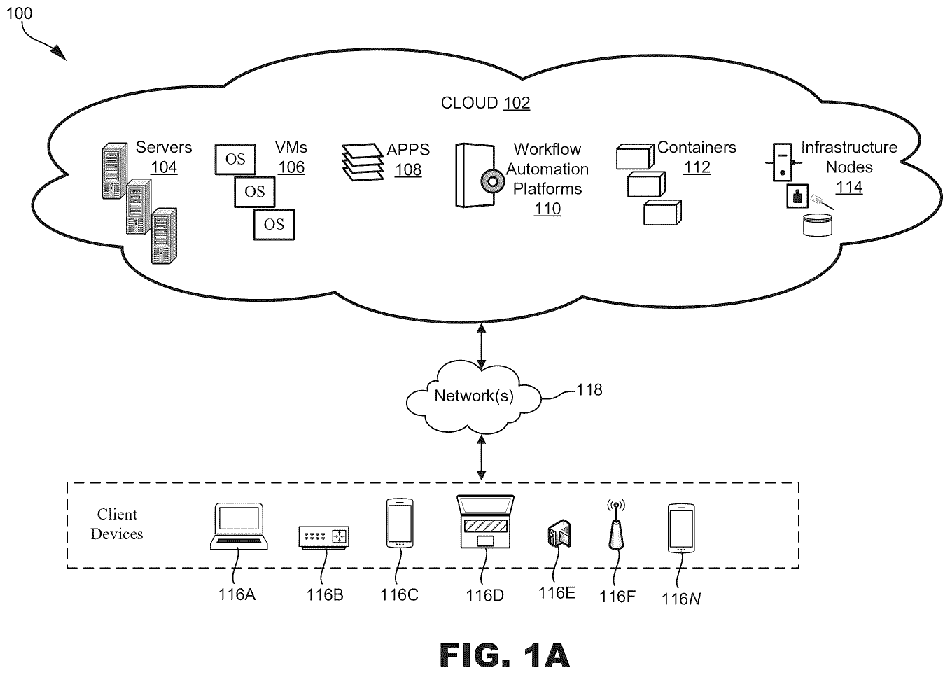

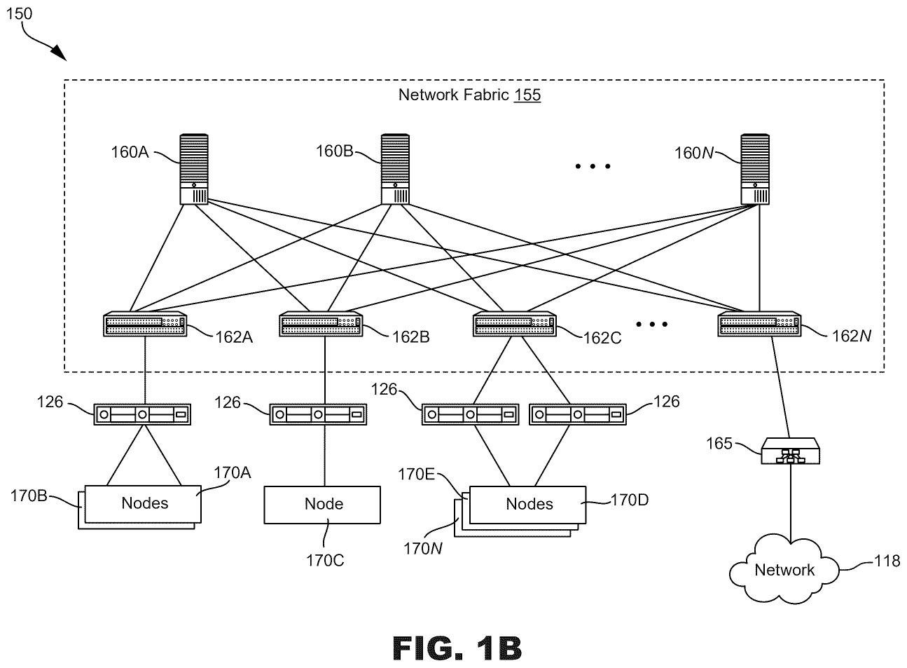

FIG. 1A illustrates a diagram of an example cloud computing environment 100 that can be used to implement a workflow automation platform, according to some examples of the present disclosure. The cloud computing environment 100 can include and/or represent a cloud 102. The cloud 102 can include one or more private clouds, public clouds, and/or hybrid clouds. Moreover, the cloud 102 can include cloud elements 104-114. The cloud elements 104-114 can include or represent, for example, servers 104, virtual machines (VMs) 106, applications or services 108, workflow automation platforms 110, software containers 112, and/or infrastructure nodes 114. The infrastructure nodes 114 can include one or more types of nodes, such as compute nodes, storage nodes, network nodes, management systems, etc.

The cloud 102 can provide cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client devices 116A-N (collectively referred to as “client devices 116” hereinafter) can connect with the cloud 102 to obtain one or more specific services from the cloud 102. The client devices 116 can connect with the cloud 102 from any network of the client devices 116 such as a local area network (wired and/or wireless), a cellular network, and/or any other network, and using the network(s) 118 to transport communications between the cloud 102 and the client devices 116. For example, the client devices 116 can communicate with the cloud 102 and/or any of the elements 104-114 via a network(s) 118. The network(s) 118 can include one or more public networks (e.g., the Internet, a wide area network, etc.), one or more private networks (e.g., one or more local area networks, one or more wireless local area networks, one or more private backbone networks, etc.), and/or one or more hybrid networks (e.g., one or more virtual private networks, one or more public and private cloud networks, etc.). The client devices 116 can include any device with networking capabilities, such as a laptop computer, a tablet computer, a server, a desktop computer, a smartphone, a network device (e.g., an access point, a router, a switch, etc.), a smart television, a smart car, a sensor system, a gaming console, a smart wearable device (e.g., smartwatch, etc.), an internet of things (IoT) device, a camera, a network printer, or any other computing device.

In some examples, the cloud 102 can implement and/or host workflow automation platforms 110 associated with one or more entities. The client devices 116 can access the workflow automation platforms 110 implemented and/or hosted in the cloud 102 to generate and/or access flows and/or flow information, as further described herein. An example network architecture that can be used to implement a network or datacenter (or any portion thereof), such as the cloud 102, is shown in FIG. 1B and further described below. In some cases, one or more services, components, devices, nodes, systems, instances, and/or portions of the example network architecture 150 shown in FIG. 1B can be implemented by and/or in a cloud network or datacenter, such as the cloud 102.

FIG. 1B is a block diagram illustrating an example network architecture 150 that can be used to implement one or more portions of the example cloud computing environment 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run workloads/nodes. In some cases, a cloud node can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the node can host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, the cloud 102. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126, the network device 165, and/or the nodes 170A-N (collectively referred to as “nodes 170” hereinafter) with any portion of the network fabric 155 (e.g., including each other). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g., network 118, various network elements, the network device 165, the nodes 170, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. For example, the system servers 126 can implement any of the applications 108 and/or the workflow automation platforms 110 hosted on the cloud 102. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170. In some examples, the nodes 170 can represent cloud instances. For example, in some cases, the nodes 170 can each represent a virtual server and/or environment (e.g., a VM, a software container, etc.) that uses compute, memory, storage, and/or networking resources on the cloud (e.g., network architecture 150) for respective workloads. For example, the nodes 170 can implement any of the applications 108 and/or the workflow automation platforms 110 hosted on the cloud 102. In some implementations, the nodes 170 can perform parallel computing using, for example, multithreading. Each of the nodes 170 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 can represent a node instance that includes, implements, hosts, and/or runs a software container(s), an application(s), and/or a workflow automation platform(s). In some examples, a software container(s) associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, and/or the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

An enterprise network and/or a workflow automation platform associated with an entity can be implemented through the cloud computing environment 100 shown in FIG. 1A and the network architecture 150 shown in FIG. 1B. For example, the user interfaces, the data structures, and the logic to implement the workflow automation platforms 110 and perform automated flow generation as described herein can be implemented through the cloud computing environment 100 and/or the network architecture 150.

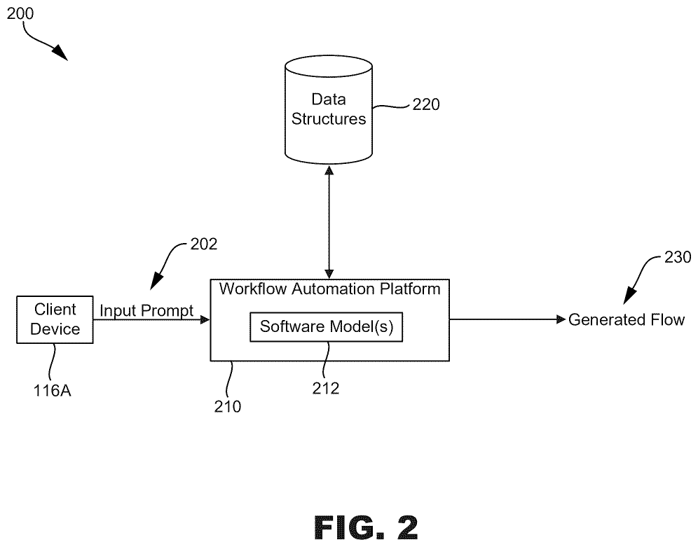

FIG. 2 is a diagram illustrating an example system process 200 for generating flows based on user inputs including metadata tags, according to some examples of the present disclosure. In this example, a user (not shown) associated with an entity can use a client device 116A to provide an input prompt 202 to a workflow automation platform 210 associated with the entity, which the workflow automation platform 210 can use to generate a flow on the workflow automation platform 210. The workflow automation platform 210 in this example can represent one of the workflow automation platforms 110 in the cloud 102 shown in FIG. 1A. For example, the workflow automation platform 210 can represent one of the workflow automation platforms 110 of (e.g., owned by, used by, managed by, subscribed to by, etc.) an entity associated with the user providing the input prompt 202. The workflow automation platform 210 can use the input prompt 202 to automatically create a flow 230, as further described herein.

The input prompt 202 can include text requesting or triggering the workflow automation platform 210 to generate a flow 230 based on the input prompt 202. In some examples, the text in the input prompt 202 can include a natural language description of the flow 230 to be generated. In some cases, the description of the flow 230 to be generated can include a linkage between a metadata tag in the input prompt 202 and a data structure(s) 222 from a data repository 220, which can be used to obtain additional information that the workflow automation platform 210 can use to generate the flow 230.

For example, the description of the flow 230 in the input prompt 202 can include a metadata tag (or multiple metadata tags). The metadata tag (or each metadata tag) can link one or more terms in the metadata tag to a data structure(s) 222 from the data repository 220. The data repository 220 can include one or more stores, databases, pools, storage devices, and/or repositories of data of an entity associated with the workflow automation platform 210. In some examples, the data repository 220 can include one or more data storage devices, components, infrastructure elements, databases, stores, and/or pools hosted by the cloud 102 shown in FIG. 1A.

The data structure(s) 222 from the data repository 220 can include information relevant to the flow 230 and/or relevant to generating the flow 230, such as context information, entity information, semantic information, a lexicon, records, flow-related data, and/or any other data used to help in generating the flow 230 and/or interpreting the text description in the input prompt 202 used to generate the flow 230. In some examples, the data structure(s) 222 associated with a metadata tag can include a database table, a database record, an instance of an object, a file, a data container, a store, a folder, a filesystem, a disk drive, a server share, a disk volume, a logical drive or volume, a data wrapper, a database (e.g., a relational database, an object-oriented database, a non-relational database, a document database, a key-pair database, a graph-based database, and/or any other database), a list, a tree, an array, a stack, a tuple, a memory region (and/or range of memory addresses), a graph, a document (e.g., an extensible markup language (XML) document, etc.), and/or any other data structure. In some cases, the metadata tag can include a hashtag included in the input prompt 202. The hashtag can be denoted using a symbol, such as the hashtag symbol (e.g., #) followed by one or more terms describing the data structure(s) 222 associated with the hashtag.

The workflow automation platform 210 can parse the text in the input prompt 202 to identify any metadata tags included in the input prompt 202. The workflow automation platform 210 can recognize a metadata tag (e.g., a hashtag) in the input prompt 202 based on the text associated with the metadata tag and/or a symbol used to designate the text associated with the metadata tag as being part of a metadata tag, such as a hashtag symbol. For example, if the metadata tag includes a hashtag, the workflow automation platform 210 can parse the input prompt 202 and identify a hash symbol used for the hashtag. Based on the hash symbol, the workflow automation platform 210 can detect that the term(s) after the hash symbol corresponds to the hashtag, and can recognize the term(s) included as part of the hashtag. The workflow automation platform 210 can use the term(s) in the hashtag to determine which data structure(s) from the data repository 220 to query for data related to the flow 230. Thus, the workflow automation platform 210 can identify a metadata tag in the input prompt 202 based on the parsing of the text in the input prompt 202.

As previously noted, the workflow automation platform 210 can identify the particular data structure linked to the metadata tag based on the text in the metadata tag. For example, the text in the metadata tag can correspond to the name of a table, a record, an object, a database field, a request, and/or any other data structure. The workflow automation platform 210 can recognize the text and link the input prompt 202 to the particular data structure identified by the workflow automation platform 210 based on the metadata tag. The workflow automation platform 210 can query the particular data structure for additional information used to generate the flow 230, such as context information and/or any other information. The workflow automation platform 210 can retrieve the information from the particular data structure and use the retrieved information to generate the flow 230 as further described herein.

In some examples, the workflow automation platform 210 can include a software model(s) 212 configured to recognize the text in the input prompt 202, determine the meaning and/or interpretation of the text in the input prompt 202, and use the text and the meaning/interpretation of the text in the input prompt 202 to generate the flow 230. For example, the software model(s) 212 can perform natural language processing (NLP) and/or natural language understanding (NLU) to understand the meaning of the text in the input prompt 202. The software model(s) 212 can use the information about the text and the meaning of the text in the input prompt 202 to determine the components of the flow 230 to be generated and identify the particular data structure 222 from the data repository 220 that is linked to the input prompt 202 by a metadata tag(s) included in the input prompt 202. The components of the flow 230 can include a trigger used to trigger the flow 230, one or more actions to be performed in response to detecting the trigger, and optionally flow logic for performing the one or more actions.

In some cases, a flow action to be performed in response to a trigger can include a conditional action and/or a repeated action, and the flow logic can specify the conditional action and/or the repeated action and one or more conditions used to trigger the conditional action and/or the repeated action. In some implementations, the flow logic associated with the flow(s) can include branching logic used to execute one or more actions associated with the flow(s). For example, the flow logic can include one or more conditions used to execute one or more conditional and/or repeated actions, such as If statements, Else statements, Else If statements, loops (e.g., For Each, Do the following until, Do the following in Parallel, etc.), While statements, utility logic (e.g., Wait for a duration of time logic used to pause a flow, Call a Workflow logic to execute a particular workflow, End logic to end flow processing within a logic branch, Dynamic Flow to execute a flow or subflow dynamically, Get Flow Outputs to obtain outputs from an embedded flow, Set Flow Variables to set variables for a flow, etc.), and/or any other logic. The software model(s) 212 implemented by the workflow automation platform 210 can recognize the flow logic based on the description of the flow 230 included in the input prompt 202.

In some implementations, the software model(s) 212 can use any metadata tag in the input prompt 202 to identify one or more data structures from the data repository 220, query the one or more data structures for information, and retrieve the information from the one or more data structures. The retrieved information can include any information that can help the software model(s) 212 interpret language (e.g., terms) in the input prompt 202 and account for any potential interpretation issues and/or variations, such as entity-based and/or context-based variations in the meaning of terms used in input prompts used to generate flows. The software model(s) 212 can thus use the retrieved information to accurately translate the input prompt 202 into the flow 230 generated from the input prompt 202. For example, the software model(s) 212 can use the retrieved information to interpret natural language in the input prompt 202 to better understand the input prompt 202 and generate the flow 230 requested by the input prompt 202.

The information obtained using a metadata tag in the input prompt 202 can include any information from any data structure (from the data repository 220) associated with the metadata tag. For example, the information retrieved from a particular data structure 222 based on a metadata tag in the input prompt 202 can include any information that is relevant to the flow 230 (and/or to generating the flow 230) such as, for example and without limitation, context information, supplemental or auxiliary information, and/or any other additional/relevant information that can help the software model(s) 212 understand the input prompt 202 and generate an accurate and/or customized flow, even if the input prompt 202 is otherwise vague, imprecise, lacks useful details, and/or otherwise lower quality.

In some implementations, the software model(s) 212 can use the input prompt 202 and the information retrieved from the data structure 222 to identify the components of the flow 230, which the workflow automation platform 210 can use to generate the flow 230 requested by the input prompt 202. The workflow automation platform 210 can use the components of the flow 230 to automatically generate the flow 230 (and, optionally, any subflows). For example, the workflow automation platform 210 can use the components of the flow 230 determined based on the input prompt 202, to generate a trigger(s) for the flow 230, an action(s) to execute in response to the trigger(s), and optionally any flow logic. In some cases, the flow 230 can include executable instructions configured to trigger a flow action(s) responsive to a flow trigger(s), according to any associated flow logic (if any). In some examples, the flow 230 generated by the workflow automation platform 210 can optionally include one or more subflows, which can include one or more respective triggers, one or more respective actions, and can optionally include any flow logic.

In some examples, the software model(s) 212 can use a metadata tag included in the input prompt 202 to identify the data structure 222 from the data repository 220 that includes information that can help the software model(s) 212 generate the flow 230 based on the input prompt 202. In some cases, the information can include a dictionary used by the entity associated with the flow 230 and/or stored data of that entity, such as data in a table, record, data object, field, file, database, etc. The information can help the software model(s) 212 interpret the terms in the input prompt 202, particularly if any of the terms have specific meanings for the entity or in the context of the entity and/or the flow 230. In some cases, the information can provide context information that the software model(s) 212 can use to ensure that the flow 230 generated based on the input prompt 202 accurately captures or correlates with the intended meaning of the terms in the input prompt 202 and the intent behind the flow 230 to be generated based on the input prompt 202.

For example, if the input prompt 202 includes text describing an action for the flow 230 and in the text the input prompt 202 includes a metadata tag with the terms “financial request”, the software model(s) 212 can recognize that the terms “financial request” are part of a metadata tag used in the input prompt 202 to correlate the action for the flow 230 with a data structure identifiable based on the terms “financial request”, such as a table named “financial request”, an object names “financial request”, a dictionary defining the terms “financial request” in the context of an entity associated with the flow 230, a record named or including the terms “financial request”, etc. The software model(s) 212 can use the metadata tag to query the data structure associated with the terms “financial request”, and retrieve information about the terms “financial request” and/or the context in which the terms are used, which the software model(s) 212 can use to help generate the flow 230. The software model(s) 212 can retrieve any relevant information from the data structure, such as context information and/or information to help interpret the terms, which the software model(s) 212 can use to assist in generating the flow 230 as described herein.

In some implementations, the software model(s) 212 can include one or more software algorithms. For example, the software model(s) 212 can include one or more AI/ML models, such as a large language model (LLM). The software model(s) 212 can implement a single AI/ML model or multiple AI/ML models. In some examples, the software model(s) 212 can implement one or more neural networks, one or more neural network heads, one or more neural network branches, one or more neural network cores, one or more neural network interfaces (e.g., application-specific interfaces (APIs), etc.), and/or any other components. Each of the one or more neural networks can include any neural network type/architecture such as, for example and without limitation, a transformer network, a convolutional neural network, an autoencoder network, a sequence-to-sequence network, a recurrent neural network, a long short-term memory network, a mixture-of-experts network, an encoder and/or decoder network (e.g., encoder-decoder network, encoder-only network, decoder-only network, etc.), and/or any other artificial and/or deep learning neural network.

In some examples, the workflow automation platform 210 can generate (e.g., via the software model(s) 212) a visual representation of the flow 230 as it generates the flow 230, which can be presented on a display of the client device 116A for a user to view the flow 230 as it is generated. For example, the workflow automation platform 210 can generate or render a visual representation of the flow 230 and add details to the visual representation of the flow 230 as the flow 230 is generated. In some examples, as the workflow automation platform 210 generates the flow 230, the workflow automation platform 210 can first generate or render an outline of the flow 230. The outline of the flow 230 can depict a visual representation of a flow trigger(s), a visual representation of a flow action(s), a visual representation of any flow logic and/or conditions, and a visual representation of interdependencies between the flow trigger(s), the flow action(s), and any flow logic and/or conditions. As the workflow automation platform 210 determines any other details of the flow trigger(s), the flow action(s), and any flow logic and/or conditions, the workflow automation platform 210 can add the details of the flow trigger(s) to visual representation of the flow trigger(s), the details of the flow action(s) to the visual representation of the flow action(s), and any details of any flow logic and/or conditions to any visual representation of the flow logic and/or conditions. This way, the user can visualize the flow 230 as the flow 230 is generated by the workflow automation platform 210. In some cases, the workflow automation platform 210 can render interface elements that the user can use to pause the generation of the flow 230 and/or make changes to the flow 230 as the flow is generated.

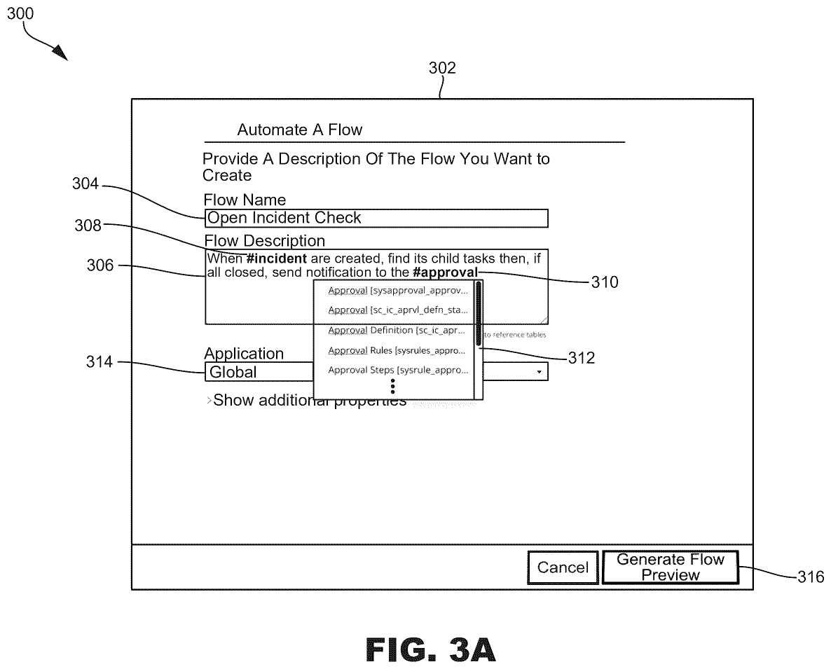

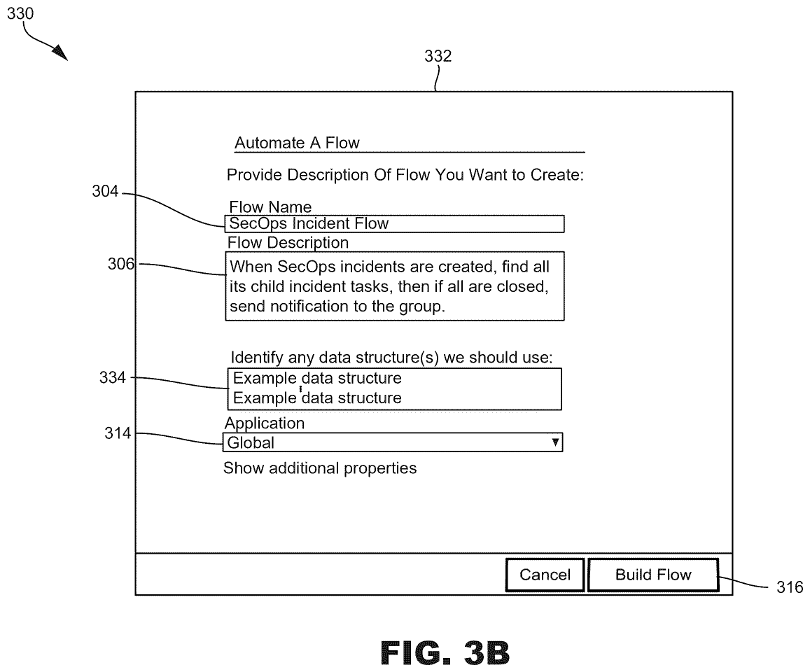

FIG. 3A is a diagram illustrating an example configuration 300 of an interface 302 for providing an input prompt (e.g., input prompt 202) used to generate a flow in a workflow automation platform, according to some examples of the present disclosure. The interface 302 can be used to generate a flow in a workflow automation platform such as the workflow automation platform 210 shown in FIG. 2. The interface 302 can be generated by the workflow automation platform 210 and served to the client device 116A for presentation to a user associated with the client device 116A, so the user can provide the input prompt used to generate the flow and any other information. The interface 302 can be rendered and displayed at the client device 116A using client-side rendering, server-side rendering, and/or any other display or rendering configuration.

In this example, the interface 302 includes a name field 304 where the user can name the flow to be generated. In the name field 304, the user can include any name used to label the flow, identify the flow, describe the flow, and/or associated with the flow. The interface 302 can also include a description field 306 where the user can provide a text description of the flow to be generated. The text description can include natural language used to describe features of the flow such as, for example, any triggers for the flow, any actions to perform in response to the triggers, and optionally any flow logic. In some examples, the text description can include metadata tags 308 and 310 that link the text in the metadata tags 308 and 310 to data structures that the workflow automation platform 210 can use to retrieve relevant information used to generate the flow.

For example, the metadata tag 308 includes the hashtag “#incident”. In this example, the hash symbol can be used by the workflow automation platform 210 to detect the “incident” pertains to a data structure named, related to, and/or identified based on the term “incident”, such as a record name “incident”, a table named “incident”, a data object named “incident”, a file named “incident”, etc. As shown, the hashtag “#incident” is included in a portion of the text description that describes a trigger for the flow; namely, that when “#incident” are created” find all its child incident tasks, among other details. Here, the workflow automation platform 210 can determine from the metadata tag 308 that the trigger indicates that when a record is created for an incident within a data structure named “incident”, such as a table or object, the action in the text description should be triggered. In some cases, the workflow automation platform 210 can access data from a relevant data structure, such as a data structure labeled “incident”, to obtain information used by the workflow automation platform 210 to understand the type of data and/or the data storage target associated with the trigger for this flow.

The metadata tag 310 includes the hashtag “#approval” in the description of an action, namely, an action to send a notification to the “#approval”. Here, the workflow automation platform 210 can detect the hash symbol ( #) and determine that the term “approval” after the hash symbol represents a metadata tag linking the term “approval” to a data structure named “approval” and/or containing information relevant to “approval”. For example, the metadata tag 310 can indicate that a notification should be sent based on a stored rule named “approval” or a stored rule used for actions associated with an “approval”, which the workflow automation platform 210 can use to determine where to send the notification in response to detecting the trigger and/or how to send the notification. To illustrate, the workflow automation platform 210 can identify the data structure corresponding to the hashtag “#approval” and use the information in the data structure to understand how to send the notification and/or where to send the notification in response to detecting the trigger.

In some cases, as the user types a metadata tag, the system can render a menu, such as a drop-down menu, with suggested options that may relate to the metadata tag. For example, as shown in FIG. 3A, as the user types “#approval” when adding the metadata tag 310, the system can render a menu 312 with possible data structures that include the term “approval” and/or relate to the term “approval”. If the user finds the desired data structure within the menu 312, the user can select the data structure to automatically add the metadata tag corresponding to that data structure.

In some implementations, the interface 302 can include an application field 314 that allows the user to indicate whether the flow or the details defined for the flow apply to a particular module, application, service, workload, process, platform feature, and/or component, or if the flow or the details of the flow apply globally to the workflow automation platform 210 associated with that entity and/or the applications, components, services, modules, workloads, processes, etc., in the workflow automation platform 210 associated with that entity.

The interface 302 can also include an interface element 316 that can be selected to build the flow once the relevant details for the flow are provided via the interface 302. For example, when the user has provided the relevant details for the flow and is ready to trigger the workflow automation platform 210 to generate the flow, the user can select the interface element 316 to trigger the workflow automation platform 210 to begin building the flow. In some cases, when the user selects the interface element 316, the interface element 316 can be configured to generate a preview of the flow for the user to see the flow and optionally make any changes to the flow. In some examples, the interface element 316 can trigger the workflow automation platform 210 to generate a rendering of the flow as the workflow automation platform 210 generates the flow, which can allow the user to visualize the flow as it is generated.

FIG. 3B is a diagram illustrating another example configuration 330 of an interface 332 for providing an input prompt (e.g., input prompt 202) used to generate a flow in a workflow automation platform, according to some examples of the present disclosure.

The interface 332 can be used to generate a flow in a workflow automation platform such as the workflow automation platform 210 shown in FIG. 2. The interface 332 can be generated by the workflow automation platform 210 and served to the client device 116A for presentation to a user associated with the client device 116A, so the user can provide the input prompt used to generate the flow and any other information. The interface 332 can be rendered and displayed at the client device 116A using client-side rendering, server-side rendering, and/or any other display or rendering configuration.

As shown, the interface 332 includes the name field 304 where the user can name the flow to be generated. The interface 332 can also include the description field 306 where the user can provide a text description of the flow to be generated. The text description can include natural language used to describe features of the flow such as, for example, any triggers for the flow, any actions to perform in response to the triggers, and optionally any flow logic. In some examples, the text description can include one or more metadata tags that link the text in the one or more metadata tags to data structures that the workflow automation platform 210 can use to retrieve relevant information used to generate the flow, as previously described.

In this example, the interface 332 can include a data structure field 334 where the user can provide any input used to identify any data structures that should be queried for information used to help the workflow automation platform 210 generate the flow. For example, the user can add the name or identifier of each data structure that the workflow automation platform 210 should retrieve information from to assist in generating the flow, such as context information, information about terminology used in the text description field 306, information about a source data structure to monitor to detect a trigger associated with the flow (e.g., a source data structure associated with a trigger for the flow which defines the trigger for the flow as retrieval of information or certain information from the source data structure such as retrieving data from a record in the source data structure), a target data structure to monitor to detect a trigger associated with the flow (e.g., a target data structure associated with a trigger for the flow which defines the trigger for the flow as saving information or certain information in the target data structure such as adding a record to the target data structure), and/or any other information.

In some implementations, the user can add any name, reference, or identifier of any data structures to consider (e.g., to query, to review or analyze, to access, etc.) by the workflow automation platform 210 when generating the flow. In some examples, the user can also add information used to correlate (or identify) or map each data structure it includes in the data structure field 334 to the flow listed in the name field 304 of the interface 332 and/or to a term(s) in the text description field 306 of the interface 332, such as a metadata tag or a term(s) used to describe a component of the flow (e.g., a trigger, an action, flow logic, etc.). For example, the user can add in the data structure field 334 a data structure to be used when generating the flow (e.g., add an identifier, reference, or name of the data structure). In addition, the user can optionally add a description of the flow (e.g., the flow identified in the name field 304 of the interface 332) and/or a portion of the flow (e.g., one or more terms or components of the flow described in the text description field 306 of the interface 332) associated with that data structure. The description of the flow and/or the portion of the flow can map the data structure to that particular flow and/or portion of the flow.

Each data structure added, identified, or listed in the data structure field 334 (if any) can include a table, a field, a record, a data object, a file, a database, a data store, a data container, a folder, a share, a drive, a data pool, a filesystem, and/or a document, a data wrapper, a list, a stack, a memory region (or range of memory addresses), and/or any other data structure. In some cases, the data structure field 334 can allow a user to reference or identify any other resources that the workflow automation platform 210 can use to obtain information that can help the workflow automation platform 210 generate the flow. For example, the user can identify or reference any dictionary of terms applicable to the entity associated with the workflow automation platform 210 and/or the context of the flow. The workflow automation platform 210 can reference any dictionary identified or referenced in the data structure field 334 when interpreting the text description of the flow in the text description field 306 and/or any terms in the text description.

For example, a specific term may have a different meaning for an entity associated with the workflow automation platform 210 than a common or generally known meaning of that term. To determine how to interpret the term, the workflow automation platform 210 can reference a dictionary identified or referenced in the data structure field 334. To illustrate, the workflow automation platform 210 can look up the term in a dictionary identified or referenced in the data structure field 334 to determine a relevant meaning of the term in the context of the entity associated with the workflow automation platform 210 and the flow being generated. The workflow automation platform 210 can thus interpret the term according to its meaning applied by the entity associated with the workflow automation platform 210 and/or within the context of the flow being generated, rather than the more common or generally known meaning of the term applied in other contexts and/or for other entities.

In some cases, the user can include or reference a dictionary of business terms that the workflow automation platform 210 can use to interpret terms in the input prompt and/or terms related to the flow. The dictionary can contain words, terminology, and/or acronyms that have specific meanings to the entity associated with the workflow automation platform 210. For example, the terms “business process” can mean a specific legacy homegrown application to a particular business, whereas the terms can have a different meaning to the public such as procedures of business operations. The dictionary can give the workflow automation platform 210 domain knowledge of terms, acronyms, and/or words that users of an entity might use in input prompts used to generate flows, and what they may mean in a certain context. The dictionary can be organized in any way, such as by grouping of synonyms, words and/or explanations, by ontology definitions, etc.

In some implementations, the interface 332 can include an application field 314 that allows the user to indicate whether the flow or the details defined for the flow apply to a particular module, application, service, workload, process, platform feature, and/or component, or if the flow or the details of the flow apply globally to the workflow automation platform 210 associated with that entity and/or the applications, components, services, modules, workloads, processes, etc., in the workflow automation platform 210 associated with that entity.

The interface 332 can also include an interface element 316 that can be selected to build the flow once the relevant details for the flow are provided via the interface 332. For example, when the user has provided the relevant details for the flow and is ready to trigger the workflow automation platform 210 to generate the flow, the user can select the interface element 316 to trigger the workflow automation platform 210 to begin building the flow. In some cases, when the user selects the interface element 316, the interface element 316 can be configured to generate a preview of the flow for the user to see the flow and optionally make any changes to the flow. In some examples, the interface element 316 can trigger the workflow automation platform 210 to generate a rendering of the flow as the workflow automation platform 210 generates the flow, which can allow the user to visualize the flow as it is generated.

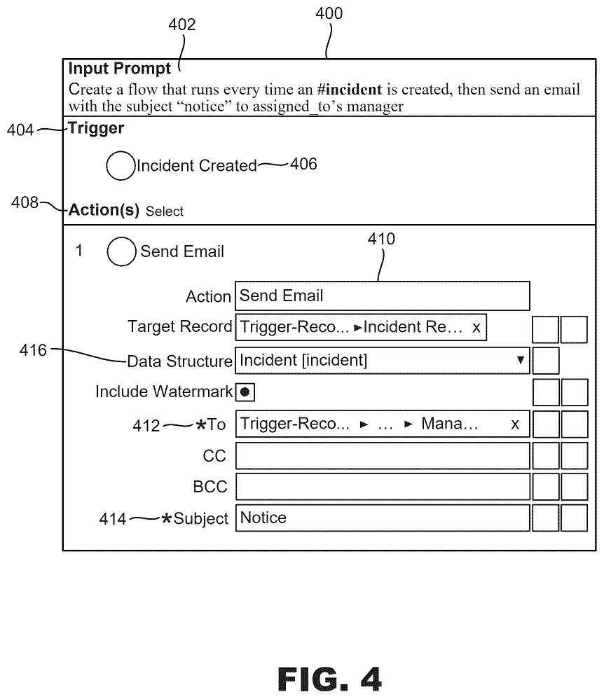

FIG. 4 is a diagram illustrating an example of an interface 400 depicting a representation of an example input prompt 402 and an example outline of a flow generated based on the input prompt 402, according to some examples of the present disclosure. In this example, the outline of flow depicted in the interface 400 is generated based on the input prompt 402 with the following description: “Create a flow that runs every time an #incident is created, and then send an email with the subject ‘notice’ to assigned_to's manager”. In this example, the action component 408 of the flow includes the action 410 to send an email, which represents the action to perform for the flow or as part of the flow. The workflow automation platform 210 can recognize the action 410 to send an email from the text in the input prompt 402 that states “send an email with the subject ‘notice’. . . .”

Moreover, the trigger component 404 of the flow includes a trigger 406 to run the action 410 to send an email, as defined in the action component 408, every time an incident is created, meaning, every time a data structure named “incident” is created or data (e.g., a record, an object, a file, etc.) is added to a data structure named “incident”. In other words, the trigger 404 triggers the action 410 to send the email, as defined in the action component 408, every time the trigger “incident created” is satisfied, which occurs when information about an incident, as understood in the context of the entity associated with the workflow automation platform 210, is created in a data structure named “incident” or every time a data structure named “incident” is created, such as a record, table, or object named “incident”.

The workflow automation platform 210 can recognize the trigger 404 from the example input prompt 402. For example, the workflow automation platform 210 can recognize the text in the example input prompt 402 and interpret the portion that states “runs every time an #incident is created” as indicating that the action 410 from the action component 408 should be executed every time a data structure named “incident” is created or modified (e.g., by adding a record, object, file, or any other information pertaining to an incident added to the data structure named “incident”). The workflow automation platform 210 can determine that the hashtag “#incident” refers to a data structure based on the hash symbol prepended to the term “incident”. The workflow automation platform 210 can determine the data structure based on the term(s) following the hash symbol, which in this case includes the term “incident”. Thus, in this example, the workflow automation platform 210 can determine, based on the hash symbol, that the term “incident’ refers to a data structure in the ecosystem of the entity associated with the workflow automation platform 210, and identify the data structure based on the term “incident”.

As shown in FIG. 4, the interface 400 includes a data structure field 416 which identifies any data structures associated with the flow. In this example, the data structure field 416 includes the data structure “incident”, which the workflow automation platform 210 recognized from the example input prompt 402 (e.g., based on the term “#incident”), as previously explained. The interface 400 also includes elements used to further define the action 410 in the action component 408. In this example, the elements include an address field 412 identifying the recipient(s) of the email from the action 410, and a subject field 414 identifying the subject of the email from the action 410.

The workflow automation platform 210 can recognize the recipient(s) of the email included in the address field 412 based on the text in the input prompt 402 that states that the email should be sent to “assigned_to's manager”. Here, the workflow automation platform 210 can determine based on the syntax of the term “assigned_to” from “assigned_to's manager”, that the recipient(s) of the email should be the manager of the person(s) assigned to the incident created as part of the trigger 404. In some cases, the workflow automation platform 210 can use information from the data structure in the data structure field 416 to help interpret the meaning of “to assigned_to's manager”. For example, the workflow automation platform 210 can determine that the data structure “incident” includes a field, record, or data object for assigning people to incidents in the data structure, and use that information to interpret the text stating “to assigned_to's manager” as meaning the manager of the person(s) assigned to the incident created.

To illustrate, the workflow automation platform 210 can check the data structure where incidents are created/stored to determine that people assigned to incidents are identified using the syntax “assigned_to”. The workflow automation platform 210 can then determine that “assigned_to” in the input prompt 402 refers to any person assigned to the incident created when the flow is triggered. The workflow automation platform 210 can recognize that the term “manager” means the manager of any person assigned to the incident created when the flow is triggered, which is defined by the text “assigned_to”, as previously explained.

The workflow automation platform 210 can determine the content of the subject field 414 based on the text in the input prompt 402 stating that the email in the action 410 should include “the subject ‘notice’”. For example, the workflow automation platform 210 can recognize that the term “subject” refers to a portion of the email (e.g., the subject) and thus determine that the subject of the email should include the term “notice”.

The example flow and interface 400 illustrated in FIG. 4 are merely illustrative examples provided for explanation purposes. One of ordinary skill in the art will recognize in view of this disclosure that in other examples, the interface 400 can include other elements and/or the flow can differ from the flow in FIG. 4.

Moreover, as previously explained, the workflow automation platform 210 can use NLP/NLU and information from the data structure identified in the input prompt 402 to understand and interpret the input prompt 402 in order to create the flow, including the trigger component 404 and the action component 408.

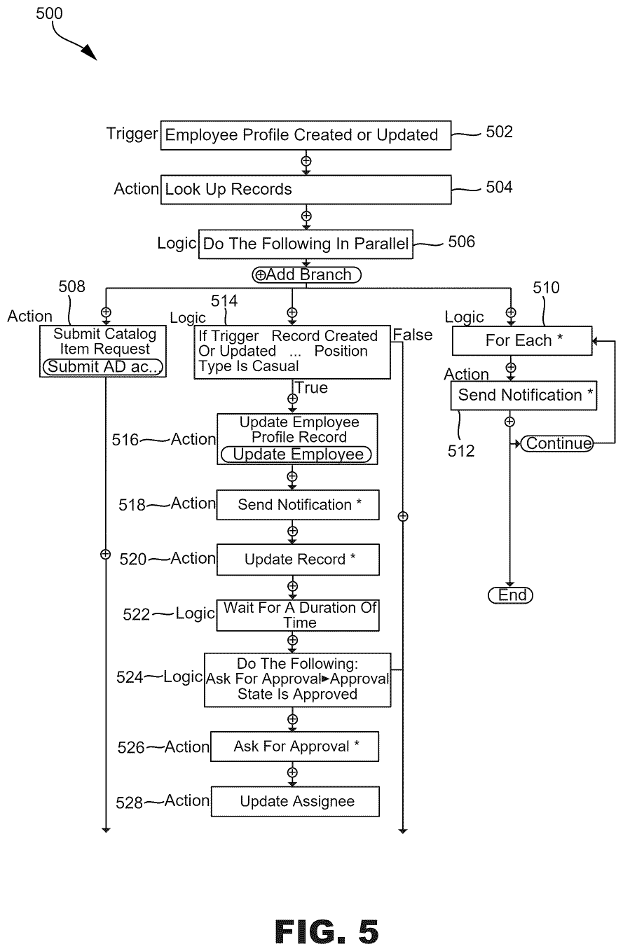

FIG. 5 is a diagram illustrating an example rendering 500 of a flow generated by the workflow automation platform 210 based on an input prompt, according to some examples of the present disclosure. In some examples, the workflow automation platform 210 can generate and present the rendering 500 of the flow as it generates the flow, and can add details of the flow to the rendering 500 as it builds the flow. In some examples, the rendering 500 can depict an outline of the flow generated by the workflow automation platform 210, and any other details of the flow.

As shown in FIG. 5, the rendering 500 includes a trigger 502 for an action 504. Here, the trigger 502 includes creation or updating of an employee profile, and the action 504 includes looking up records. Thus, the trigger 502 and action 504 specify that when an employee profile is created or updated, the workflow automation platform 210 should look up records.

The rendering 500 also includes flow logic 506 specifying that the action 508, the flow logic 510, and the flow logic 514 should be performed in parallel. The action 508 in this example includes an action to submit a catalog item request. The flow logic 510 indicates that for each record found or looked up when performing the action 504, perform the action 512 which in this example includes sending a notification. The flow logic 514 indicates that if the position type of a record created or updated according to the trigger 502 is “Casual”, perform the action 516, which in this example includes updating the employee profile record, the action 518, which in this example includes sending a notification, and perform the action 520, which in this example includes updating the record.

The flow logic 522 indicates that after performing the action 520, the flow should wait for a duration of time, such as a predetermined time interval. The flow logic 524 indicates that, after waiting for the duration of time, do the action 526, which in this example includes asking for approval. The rendering 500 further includes the action 528 after the action 526. The action 528 for the flow in this example includes updating an assignee associated with the record.

The clarity, precision, and/or specificity of the flow depicted in the rendering 500 can at least in part depend on the clarity, precision, and/or specificity of the input prompt used to create the flow. For example, the flow depicted in the rendering 500 shown in FIG. 5 may have more specific details in other cases where the input prompt is less vague (e.g., includes more details) and/or references more data (e.g., via one or more metadata tags) that the workflow automation platform 210 can use to obtain information that can help create the flow, such as context information.

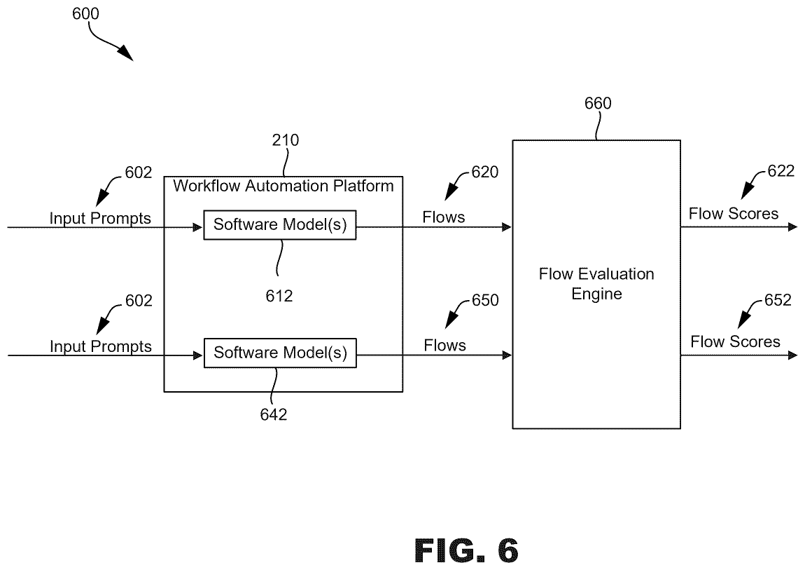

FIG. 6 is a diagram illustrating an example system process 600 for evaluating flows generated by different versions of software of the workflow automation platform 210, according to some examples of the present disclosure. The system process 600 can be used to score the performance, accuracy, precision, specificity, value, and/or qualities of flows generated by different versions of software of the workflow automation platform 210, such as the software model(s) 612 and the software model(s) 642 used by the workflow automation platform 210 to generate the flows 620 and 650, respectively. In some cases, the flow scores can be used to test the performance, accuracy, precision, specificity, creativity, and/or results of the software model(s) 612 and the software model(s) 642 used by the workflow automation platform 210. For example, in some implementations, the flow scores can be used to perform A/B testing of the software model(s) 612 and the software model(s) 642 developed for the workflow automation platform 210 before releasing the software model(s) used by the workflow automation platform 210, putting the software model(s) into production, and/or the designating the software model(s) from beta to stable.

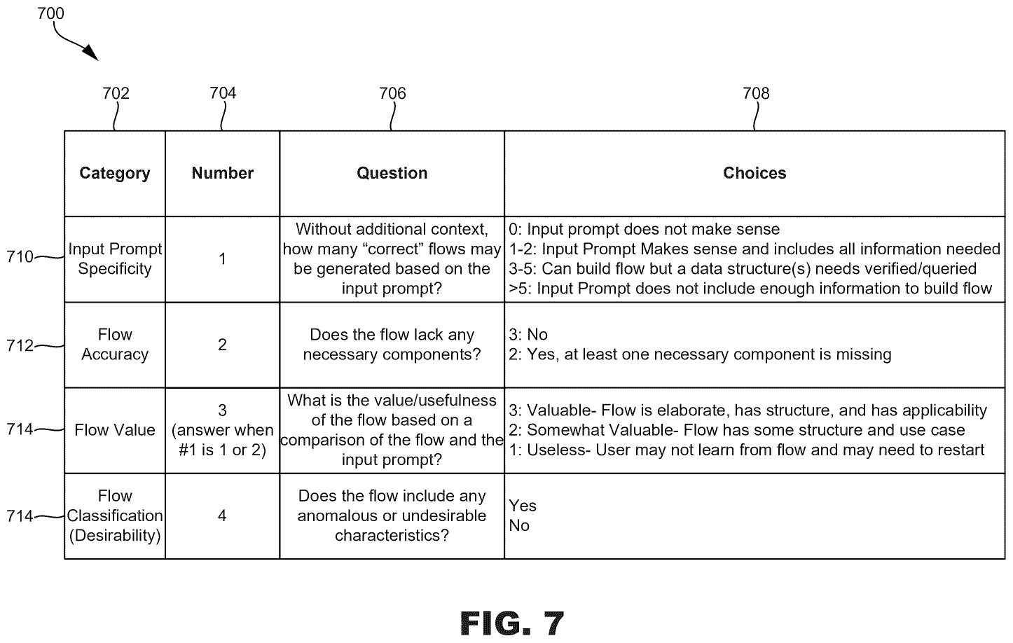

As shown, the software model(s) 612 implemented by the workflow automation platform 210 can receive a set of input prompts 602, which the software model(s) 612 can use to generate the flows 620. A flow evaluation engine 660 can receive the flows 620 from the software model(s) 612 and generate flow scores 622 corresponding to the flows 620. The flow scores 622 can measure a performance, precision, accuracy, value/usefulness, condition, and/or quality of each of the flows 620 generated by the software model(s) 612. In some cases, the flow evaluation engine 660 can use a scoring rubric as shown in FIG. 7 to generate the flow scores 622.

The flow evaluation engine 660 can include one or more software algorithms and/or models. For example, in some cases, the flow evaluation engine 660 can include a software algorithm(s) configured to detect and understand components of the flows 620 and score the flows 620 as described herein. In some cases, the flow evaluation engine 660 can additionally or alternatively include an AI/ML model(s), such as an LLM, a convolutional neural network, and/or any other AI/ML model/network. In some examples, the flow evaluation engine 660 can include one or more software models implemented at the cloud 102 shown in FIG. 1.

In addition, the software model(s) 642 of the workflow automation platform 210 can receive the set of input prompts 602 and generate the flows 650 based on the set of input prompts 602. The flow evaluation engine 660 can receive the flows 650 from the software model(s) 642 and generate flow scores 652 corresponding to the flows 650. The flow scores 652 can measure a performance, precision, accuracy, value/usefulness, condition, and/or quality of each of the flows 650 generated by the software model(s) 642. In some cases, the flow evaluation engine 660 can use a scoring rubric as shown in FIG. 7 to generate the flow scores 652.

In some examples, the flow evaluation engine 660 can compare the flow scores 622 and the flow scores 652 to test the performance, accuracy, precision, quality, and/or capabilities of the software model(s) 612 and the software model(s) 642. In some cases, the flow evaluation engine 660 can use the flow scores 622 and the flow scores 652 to perform A/B testing to test the software model(s) 612 and the software model(s) 642.

In some implementations, the flow evaluation engine 660 can check whether the flow scores 622 or the flow scores 652 equal to or exceed a threshold flow score. For example, the flow evaluation engine 660 can check whether an average or median flow score from the flow scores 622 is equal to or exceeds the threshold flow score, and/or whether the lowest flow score from the flow scores 622 is equal to or exceeds the threshold flow score. Similarly, the flow evaluation engine 660 can check whether an average or median flow score from the flow scores 652 is equal to or exceeds the threshold flow score, and/or whether the lowest flow score from the flow scores 652 is equal to or exceeds the threshold flow score.

If the flow scores 622 equal to or exceed the threshold flow score (e.g., if the average or median of the flow scores 622 equal to or exceed the threshold flow score and/or if a minimum flow score from the flow scores 622 equals to or exceeds the threshold flow score), the flow evaluation engine 660 can determine that the performance of the software model(s) 612 satisfies a threshold and/or is deemed satisfactory. Otherwise, the flow evaluation engine 660 can determine that the software model(s) 612 may need to be modified to improve its performance. In some cases, if the flow evaluation engine 660 determines that the software model(s) 612 may need to be modified to improve its performance, the flow evaluation engine 660 may use the set of input prompts 602, the flows 620, and/or the flow scores 622 as feedback (and/or to generate feedback) that can be used to modify the software model(s) 612 to improve its performance. For example, the flow evaluation engine 660 can use the set of input prompts 602, the flows 620, and the flow scores 622 to determine that the software model(s) 612 needs to improve its ability to generate flows using input prompts that lack a certain amount of specificity, its creativity to generate quality flows from vague or other input prompts, its ability to generate valuable flows, its ability to obtain context information that it can use to improve the flows it generates, and/or any other feedback.

If the flow scores 652 for the flows 650 generated by the software model(s) 642 equal to or exceed the threshold flow score (e.g., if the average or median of the flow scores 652 equal to or exceed the threshold flow score and/or if a minimum flow score from the flow scores 652 equals to or exceeds the threshold flow score), the flow evaluation engine 660 can determine that the performance of the software model(s) 642 satisfies a threshold and/or is deemed satisfactory. Otherwise, the flow evaluation engine 660 can determine that the software model(s) 642 may need to be modified to improve its performance. In some cases, if the flow evaluation engine 660 determines that the software model(s) 642 may need to be modified to improve its performance, the flow evaluation engine 660 may use the set of input prompts 602, the flows 650, and/or the flow scores 652 as feedback (and/or to generate feedback) that can be used to modify the software model(s) 642 to improve its performance. For example, the flow evaluation engine 660 can use the set of input prompts 602, the flows 650, and the flow scores 652 to determine that the software model(s) 642 needs to improve its ability to generate flows using input prompts that lack a certain amount of specificity, its creativity to generate quality flows from vague or other input prompts, its ability to generate valuable flows, its ability to obtain context information that it can use to improve the flows it generates, and/or any other feedback.

FIG. 7 is a diagram illustrating an example scoring rubric 700 that the flow evaluation engine 660 can use to evaluate flows from software model versions of a workflow automation platform, according to some examples of the present disclosure. For example, the flow evaluation engine 660 can use the example scoring rubric 700 to generate the flow scores 622 and the flow scores 652.

In this example, the scoring rubric 700 includes a scoring category 702, category number 704, a question 706 implemented for the scoring category 702, and scoring choices 708 for each scoring category. The first scoring category in this example includes an input prompt specificity 710 (and/or vagueness) used to measure how specific or vague an input prompt is. The input prompt specificity 710 can select a score from the scoring choices 708 by determining how many “correct” flows (e.g., flows deemed to be correct) may be generated based on the input prompt without additional context (and/or other information).

In this example, if the input prompt does not make any sense, the flow evaluation engine 660 can select a particular score for the input prompt, if the input prompt makes sense and includes all of the information needed to start building the flow, the flow evaluation engine 660 can assign the input prompt another score, if the input prompt has enough information to start building the flow but a data structure(s) associated with the input prompt and/or the flow may need to be verified or queried for additional information, the flow evaluation engine 660 may assign a different score to the input prompt, and if the input prompt does not include enough information to even start building the flow and needs more clarification, the flow evaluation engine 660 can assign yet another score to the input prompt. The score measuring the input prompt specificity 710 can be used to determine whether to calculate a flow value 714 for the flow generated based on such input prompt, as further described below.

The next scoring category is a flow accuracy 712, which measures an accuracy/correctness of the flow generated from an input prompt. In some examples, the flow accuracy 712 is based on a determination of whether the flow generated based on an input prompt lacks any necessary components. If the flow evaluation engine 660 determines that the flow is not missing any necessary components, the flow evaluation engine 660 can assign a flow accuracy score to the flow. Otherwise, the flow evaluation engine 660 can assign a different flow accuracy score to the flow that reflects a lower flow accuracy.

The flow value 714 can be determined for a flow if the score or the associated input prompt from the input prompt specificity 710 matches a certain value or is within a certain range. For example, the flow value 714 for a flow can be determined if the input prompt specificity 710 calculated for the input prompt used to generate the flow has a score indicating that the prompt makes sense and includes the information needed to start building the flow.

To determine the flow value 714 of a flow, the flow evaluation engine 660 can determine what is the value/usefulness of the flow based on a comparison of the flow and the input prompt used to generate the flow. For example, the flow evaluation engine 660 can assign the flow a score indicating that the flow is valuable if the flow evaluation engine 660 determines that the flow is elaborate (e.g., has a threshold specificity), has a threshold amount of structure (e.g., trigger, action, flow logic, interdependencies, etc.), and/or has one or more relevant business use cases. On the other hand, the flow evaluation engine 660 can assign the flow a score indicating that the flow is somewhat valuable if the flow evaluation engine 660 determines that the flow has some structure and business use case, but does not have all the structure or information needed to build the flow and/or does not demonstrate the full spectrum of what can be achieved for the business use case (e.g., the flow has less applicability than the flow could otherwise have if built differently). The flow evaluation engine 660 can instead assign the flow the lowest value score indicating that the flow is not valuable (is useless) if the flow evaluation engine 660 determines that the user will likely learn little or nothing from the flow and/or may need to delete the flow and start over from scratch.

In some examples, the flow evaluation engine 660 can also determine a flow classification 714 for the flow. The flow classification 714 can classify the flow as desirable/undesirable, safe/unsafe, and/or anomalous (or not anomalous). In some cases, to determine the flow classification 714, the flow evaluation engine 660 can check whether the flow includes any characteristics predetermined to be or indicate that the flow is/includes undesirable characteristics and/or anomalous characteristics. For example, the flow evaluation engine 660 can include a set of reference terms that are deemed unsafe and/or undesirable. The flow evaluation engine 660 can check if the flow includes any of such terms, and classify the flow based on whether the flow includes any of such terms. In some cases, the flow evaluation engine 660 can additionally or alternatively determine whether the flow includes or conveys any information classified as private information, such as information that discloses user-identifiable private/confidential information, trade secret information, and/or any other blacklisted information.

In some cases, the flow evaluation engine 660 can additionally or alternatively process the flow through an anomaly detection model configured to identify patterns in flows to detect any anomalous patterns or characteristics of a flow. The anomaly detection model can then classify the flow as including any anomalous patterns and/or characteristics. In some examples, the anomaly detection model can be trained using ground truth flows classified as anomalous and ground truth flows classified as not anomalous, to learn how to detect whether a flow is anomalous or not.

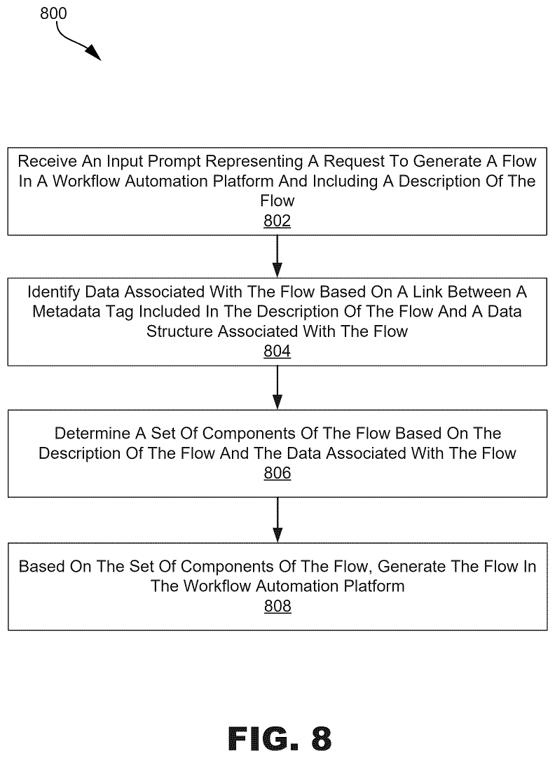

FIG. 8 is a flowchart illustrating an example method 800 for automatically generating flows in a workflow automation platform based on input prompts, according to some examples of the present disclosure. The method shown in FIG. 8 is provided by way of example, as there are a variety of ways to carry out the method. Additionally, while the example method 800 is illustrated with a particular order of steps, those of ordinary skill in the art will appreciate that the method 800 shown in FIG. 8 can be executed in any order and can include fewer or more steps than illustrated in FIG. 8. Each block shown in FIG. 8 represents one or more steps, processes, methods, actions, and/or routines in the method 800. The method 800 will be discussed with respect to the examples shown in FIGS. 1A, 2, and 6, among others. However, it should be noted that method 800 is not limited to those examples.

At block 802, the workflow automation platform 210 can receive an input prompt representing a request to generate a flow in the workflow automation platform 210 and including a description of the flow. The workflow automation platform 210 can use the input prompt to generate the flow as described herein. The input prompt can include text representing the request and/or requesting the flow, such as natural language text. The input prompt can also include a text description (e.g., in natural language) of the flow to be generated. In some examples, the input prompt can include an input in natural language text. In other examples, the input prompt can include a voice command including the description of the flow. In such examples, the workflow automation platform 210 can recognize the voice command and generate a text or transcript of the voice command that the workflow automation platform 210 can use as the input prompt.

In some examples, the description of the flow can include a metadata tag(s) that provides a link to a data structure(s) identified based on and/or corresponding to the metadata tag(s). In some examples, the description of the flow can provide a linkage between a metadata tag(s) and a data structure(s) that can be accessed to obtain additional information that can be used to generate the flow.

The natural language description of the flow can provide users a simple and intuitive way to provide information about a desired flow, and can advantageously be used by the workflow automation platform 210 to determine how to generate the flow, what to include in the flow, and build the flow. The linkage between a metadata tag(s) and a data structure(s) provided by the description of the flow can allow the workflow automation platform 210 to better understand the description of the flow, determine what is needed to create the flow, determine how to interpret terms in the description of the flow, and/or obtain additional information that can help the workflow automation platform 210 build the flow, such as context information relevant to the flow and an entity associated with the flow, terminology information, systems information, etc. Moreover, the data from the data structure(s) can be used to obtain additional information for generating the flow, and thus avoiding asking users to provide additional information and allow users with different abilities to describe flows to automatically create accurate flows via the workflow automation platform 210.

For example, the data structure(s) can include a table, a database record, a field, a form, a document, a file, a filesystem, a data store, a data object, a content item, a folder, a library, a repository, a database, and/or any other data structure. The linkage between the metadata tag(s) and the data structure(s) provided via the description of the flow can allow the workflow automation platform 210 to identify the data structure(s) that contains information relevant to the flow (and/or to a component(s) of the flow) and query the data structure(s) for information that the workflow automation platform 210 can use to build the flow. To illustrate, if the description of the flow includes a reference to a “financial request”, the terms “financial request” may have different meanings for different entities. For example, to a particular entity, the “financial request” can mean a specific type of request, whereas to another entity it may refer to a particular database table.

In the previous example, to generate an accurate flow, the workflow automation platform 210 can determine the more precise meaning of the terms “financial request” in the context of the entity associated with the workflow automation platform 210 and the flow being generated. If the workflow automation platform 210 determines that the “financial request” terms refer to a database table, the workflow automation platform 210 can assign the correct interpretation to the “financial request”. Here, the workflow automation platform 210 can identify the table named “financial request” and access the table for information that can help the workflow automation platform 210 to generate the flow (and/or one or more components of the flow that are related to that table) and/or information that the workflow automation platform 210 can use to help interpret one or more terms in the description of the flow.

In some cases, the description of the flow can include a metadata tag(s), and the metadata tag(s) can link one or more terms in the metadata tag(s) to the data structure(s). For example, the description of the flow can include a metadata tag with the terms “financial request”, which the workflow automation platform 210 can interpret as linking the description of the flow (and/or the metadata tag in the description of the flow) to a data structure named “financial request” or identified based on the terms “financial request”, such as a table, record, instance of an object, field, or document named “financial request” or identified based on the terms “financial request”.

At block 804, the workflow automation platform 210 can identify data associated with the flow based on a link between a metadata tag(s) included in the description of the flow and a data structure(s) associated with the flow (e.g., a data structure(s) associated with the metadata tag(s)). For example, the workflow automation platform 210 can identify the data structure(s) and query the data structure(s) for information that can help the workflow automation platform 210 generate the flow and/or interpret one or more terms in the description of the flow used to generate the flow.

The data structure(s) can advantageously include additional information that may be relevant to the flow. Since the workflow automation platform 210 can access from the data structure(s) for additional information, the data structure(s) can not only help the workflow automation platform 210 to generate a more accurate and/or detailed flow even if the description of the flow does not include all the information the workflow automation platform 210 needs to generate the flow. In other words, the information from the data structure(s) can reduce the burden on the user to provide more detailed input prompts and/or flow descriptions used to generate flows, as the workflow automation platform 210 can access any additional or missing information that can help generate the flow from the data structure(s).

In some examples, the information from the data structure(s) can include context information that can help the workflow automation platform 210 generate a correct flow and/or correctly interpret the description of the flow. Thus, the workflow automation platform 210 can leverage the data structure(s) to supplement the information in the description of the flow provided by a user with additional, relevant information to generate a more complete and/or accurate flow, and can help the workflow automation platform 210 to generate better prompts with less information from the user than the workflow automation platform 210 could otherwise generate if it only relied on the information provided by the user in the input prompt.

In some examples, the description of the flow can include the metadata tag(s) and the metadata tag(s) can include a hashtag(s). Here, the workflow automation platform 210 can parse the input prompt and identify the hashtag(s) based on the parsing of the input prompt. The workflow automation platform 210 can then query the data structure(s) based on the hashtag(s) (e.g., identified/queried based on the hashtag(s)) and retrieve the data associated with the flow from the data structure(s) based on the querying of the data structure(s). The workflow automation platform 210 can use the information to help build the flow and/or interpret any terms in the input prompt, as further described herein.

At block 806, the workflow automation platform 210 can determine a set of components of the flow based on the description of the flow and the data associated with the flow (e.g., the data obtained based on the link between the metadata tag(s) included in the description of the flow and the data structure(s) associated with the flow). The set of components can include one or more actions to perform for the flow, one or more triggers configured to trigger/initiate the one or more actions, and optionally any flow logic such as branch logic and conditional statements, logic loops, if/else statements, do/while statements, do/until statements, wait for a time duration statements, for each statements, conditional actions, and/or any other flow logic.

For example, in some cases, the set of components of the flow can include flow logic that includes or defines one or more conditions used to execute one or more conditional and/or repeated actions, If statements, Else statements, Else If statements, loops (e.g., For Each, Do the following until, Do the following in Parallel, etc.), While statements, utility logic (e.g., Wait for a duration of time logic used to pause a flow, Call a Workflow logic to execute a particular workflow, End logic to end flow processing within a logic branch, Dynamic Flow to execute a flow or subflow dynamically, Get Flow Outputs to obtain outputs from an embedded flow, Set Flow Variables to set variables for a flow, etc.), and/or any other logic.

The workflow automation platform 210 can determine the set of components to build an accurate and sufficiently detailed flow based on the text representing the request to generate the flow and the description of the flow. The set of components can provide the logic or intelligence of the flow and define what the flow does when and how. This way, the workflow automation platform 210 can generate a flow that is useful, accurate, flexible, and/or can account for any conditions to make decisions.

In some cases, the flow can include one or more subflows, and the set of components can include a set of components for the flow and a respective set of components for each subflow. For example, the set of components can include a trigger and an action to execute for the flow, and branching logic to determine when and/or how to implement one or more additional triggers and actions for one or more subflows.

In some implementations, the description of the flow can include a description of the set of components of the flow, and the workflow automation platform 210 can determine the set of components of the flow by determining, based on the data associated with the flow, a context associated with the flow and/or an entity associated with the workflow automation platform 210; based on the description of the set of components of the flow, interpreting a meaning of the set of components of the flow with respect to the context associated with the flow and/or the entity; and determining the flow trigger and the flow action for the flow based on the meaning of the set of components of the flow with respect to the context associated with the flow and/or the entity.

At block 808, the workflow automation platform 210 can generate the flow in the workflow automation platform 210 based on the set of components determined for the flow. For example, if the set of components includes a trigger, an action, and optionally flow logic, the flow generated by the workflow automation platform 210 can include executable instructions configured to trigger the action in response to detecting the trigger and according to the flow logic (if any). The executable instructions can be executed by the workflow automation platform 210, a client device, and/or any other device to perform the flow.

In this way, the workflow automation platform 210 can automatically and seamlessly generate accurate and/or complete flows for users/entities even with minimal information from the users and/or while reducing the burden on the users to provide all of the information needed to generate the flow and/or to have a certain amount of clarity and/or detail in the information provided for generating the flows. For example, the workflow automation platform 210 can automatically generate flows for a user based on a simple natural language input from the user that provides a description of the flow. If the information in the input is vague, unclear, or missing details, the workflow automation platform 210 can identify a relevant data structure(s), as previously described, which the workflow automation platform 210 can use to access additional information that the workflow automation platform 210 can use to build the flow, interpret terms in the input used to generate the flow, understand a context relevant to the flow, and/or any other details that can result in more accurate, complete, precise, and/or detailed flows.

In some implementations, the workflow automation platform 210 can generate a rendering of the flow as the flow is generated. The rendering can include a visual representation of the flow provided as the flow is generated. In some examples, the workflow automation platform 210 can render an outline of the flow including a first representation of the flow trigger, one or more representations of one or more conditions associated with the flow action, a second representation of the flow action, and/or any interdependencies associated with the flow trigger, the one or more conditions, and/or the flow action. The workflow automation platform 210 can then add one or more details of the flow trigger to the first representation of the flow trigger, respective details of the one or more conditions to the one or more representations of the one or more conditions, and one or more details of the flow action to the second representation of the flow action. This way, the workflow automation platform 210 can provide the user a visual outline of the flow as it generates the flow, and can add details to the visual outline of the flow as it determines those details and builds the flow.

In some implementations, the workflow automation platform 210 can determine a first set of accuracy scores for a first set of flows created by a first version of a software model(s) of the workflow automation platform 210 based on a first set of input prompts, and determine a second set of accuracy scores for a second set of flows created by a second version of the software model(s) of the workflow automation platform 210 based on a second set of input prompts. In some examples, each of the first set of accuracy scores represents an estimated degree of accuracy of a respective flow from the first set of flows, and each of the second set of accuracy scores represents an estimated degree of accuracy of a respective flow from the second set of flows. The workflow automation platform 210 can then determine a first performance of the first version of the software model(s) based on the first set of accuracy scores determined for the first set of flows created by the first version of the software model(s), and a second performance of the second version of the software model(s) based on the second set of accuracy scores determined for the second set of flows created by the second version of the software model(s). In some examples, the workflow automation platform 210 can compare the first performance of the first version of the software model(s) with the second performance of the second version of the software model(s) to determine relative performances of the different versions of the software model(s) used by the workflow automation platform 210.

In some cases, the workflow automation platform 210 can determine whether the respective flow from the first set of flows includes any characteristic classified as undesirable and/or anomalous. In some examples, an accuracy score from the first set of accuracy scores determined for each respective flow from the first set of flows can be further based on whether the respective flow from the first set of flows includes any characteristic classified as undesirable and/or anomalous. The workflow automation platform 210 can also determine whether the respective flow from the second set of flows includes any characteristic classified as undesirable and/or anomalous, and the accuracy score from the second set of accuracy scores determined for each respective flow from the second set of flows can be further based on whether the respective flow from the second set of flows includes any characteristic classified as undesirable and/or anomalous.

In some implementations, the workflow automation platform 210 can determine a first set of specificity scores for the first set of input prompts used by the first version of the software model(s) to create the first set of flows and determine a second set of specificity scores for the second set of input prompts used by the second version of the software model(s) to create the second set of flows. In some examples, each of the first set of specificity scores and the second set of specificity scores represents an estimated degree of specificity of a respective input prompt from the first set of input prompts and the second set of input prompts. The workflow automation platform 210 can determine, based on the first set of specificity scores and the second set of specificity scores, whether to calculate a respective usefulness score for any flows from the first set of flows and the second set of flows. The respective usefulness score can measure an estimated flow quality and/or an estimated flow value.

In response to determining to calculate the respective usefulness score for one or more flows from the first set of flows and one or more flows from the second set of flows, the workflow automation platform 210 can calculate the respective usefulness score for the one or more flows from the first set of flows and the one or more flows from the second set of flows. In some examples, the accuracy score for each of the one or more flows from the first set of flows can be determined further based on the respective usefulness score for the one or more flows from the first set of flows, and the accuracy score for each of the one or more flows from the second set of flows can be determined further based on the respective usefulness score for the one or more flows from the second set of flows.

The disclosure now turns to a further discussion of example software models and devices that can be used to implement the technologies described herein.

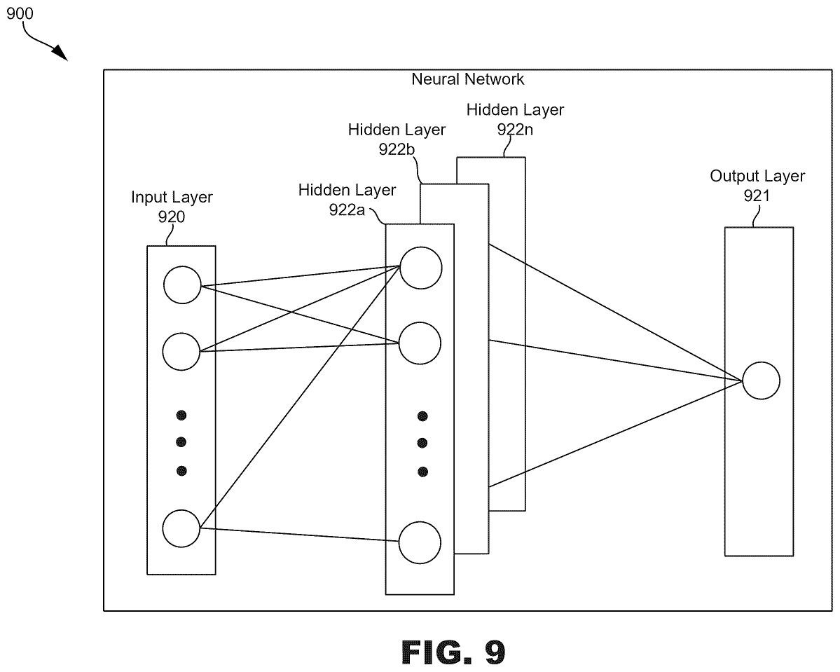

FIG. 9 is a diagram illustrating an example of a deep learning neural network 900 that can be used to implement all or a portion of the systems and techniques described herein, according to some examples of the present disclosure. For example, the neural network 900 can be used to implement the software model(s) 212 of the workflow automation platform 210, the software model(s) 612, the software model(s) 642, the flow evaluation engine 660, and/or any other software model(s) described herein (and/or component thereof).

An input layer 920 can be configured to receive data such as data included in an input prompt(s), data from a flow(s) generated by the workflow automation platform 210, flow scores, and/or any other data described herein. Neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. Neural network 900 further includes an output layer 921 that provides an output resulting from the processing performed by the hidden layers 922a, 922b, through 922n.

Neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the first hidden layer 922a can transform the information of each input node by applying activation functions to the input node information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 921, at which an output is provided. In some cases, while nodes in the neural network 900 are shown as having multiple output lines, a node can have a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 920 using the different hidden layers 922a, 922b, through 922n in order to provide the output through the output layer 921.

In some cases, the neural network 900 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 900 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 900 can perform a backward pass by determining which inputs (weights) most contributed to the loss of the network, and can adjust the weights so that the loss decreases and is eventually minimized.

The neural network 900 can include any suitable deep network. One example neural network includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 900 can include any other deep network other than a CNN, such as a transformer, autoencoder, Deep Belief Net (DBN), Recurrent Neural Network (RNN), an encoder and/or decoder network, among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

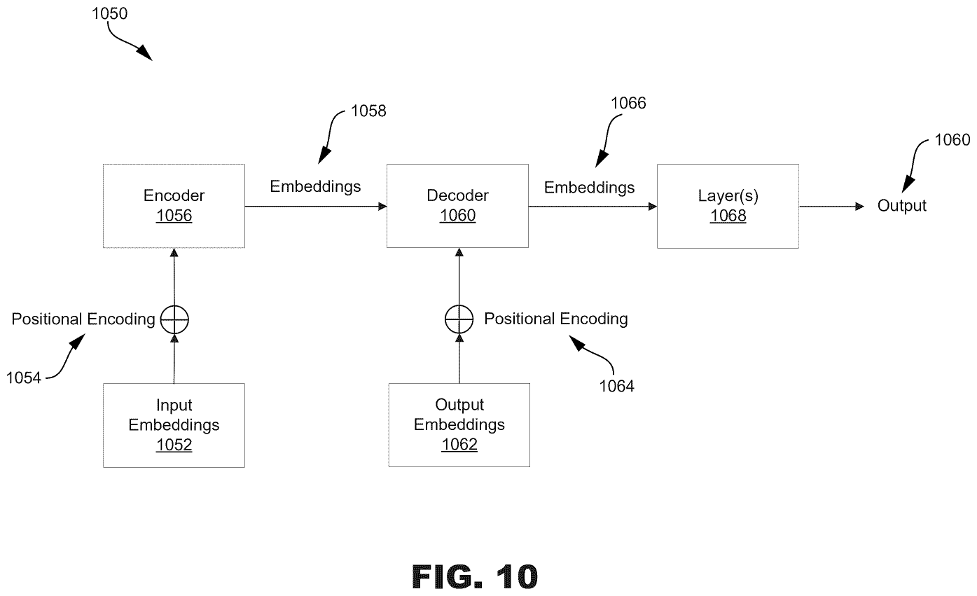

FIG. 10 is a diagram illustrating an example architecture of an example transformer model 1050, according to some examples of the present disclosure. The transformer model 1050 can be used to implement an LLM that can be used to implement the technologies described herein. For example, the transformer model 1050 can be used to implement the software model(s) 212 of the workflow automation platform 210, the software model(s) 612, the software model(s) 642, the flow evaluation engine 660, and/or any other software model(s) described herein (and/or component thereof).

As shown, the transformer model 1050 can include input embeddings 1052 used as inputs to the transformer model 1050. The input embeddings 1052 can include input values representing words and/or sentences, such as numbers or vectors representing words and/or sentences.

In some cases, the input embeddings 1052 can function like a dictionary that helps the transformer model 1050 understand the meaning of words by placing them in an embedding space where similar words are located near each other. In some examples, the input interface 134 can be trained and/or configured to create the input embeddings 1052 so that similar vectors represent words with similar meanings. In some examples, the transformer model 1050 can additionally or alternatively learn to create and/or process the input embeddings 1052 during training.

The transformer model 1050 can use positional encoding 1054 to encode the position of each word in an input sequence from the input embeddings 1052 as values such as a set of numbers, a vector, etc. The values generated by the positional encoding 1054 can be fed into the transformer model 1050 along with the input embeddings 1052. By incorporating the positional encoding 1054 into the transformer model 1050, the transformer model 1050 can more effectively understand the order of words in a sentence and generate grammatically correct and semantically meaningful output.

The transformer model 1050 can include an encoder(s) 1056 used to process the positionally encoded input embeddings 1052 and generate embeddings 1058. The encoder(s) 1056 can be part of the transformer model 1050 that processes input text and generates hidden states that capture the meaning and context of the text. For example, the encoder(s) 1056 can include a feed-forward neural network that is part of the transformer model 1050. In some examples, the encoder(s) 1056 can implement multiple encoder layers. In some cases, the encoder(s) 1056 can first tokenize the input text into a sequence of tokens, such as individual words or subwords. The encoder(s) 1056 can then apply one or more self-attention layers, which can generate hidden states that represent the input text at different levels of abstraction. In this way, the encoder(s) 1056 can generate the embeddings 1058 (e.g., a vector, a set of values, etc.) representing the semantics and position of words in one or more sentences.

The transformer model 1050 can include output embeddings 1062, which can include values representing words and/or sentences, such as numbers or vectors representing words and/or sentences. The output embeddings 1062 can be similar to the input embeddings 1052 and can also be processed by positional encoding 1064 to encode the position of each word in a sequence from the output embeddings 1062 as values such as a set of numbers, a vector, etc., which helps the transformer model 1050 understand the order of words in a sentence. The output embeddings 1062 can be used during a training phase of the transformer model 1050 and can be used during an inference phase. During training, a loss function can be computed based on the output embeddings 1062 and used to update the model parameters to improve the accuracy of the transformer model 1050. During an inference phase, the output embeddings 1062 can be used to generate the output text by mapping the predicted probabilities determined by the transformer model 1050 for each token to the corresponding token in the vocabulary.

The positionally encoded input embeddings 1052 (e.g., the embeddings 1058) and the positionally encoded output embeddings 1062 can be fed to a decoder(s) 1060 used to generate the output sequence based on the encoded input sequence. During training, the decoder(s) 1060 can learn how to guess the next word of a sequence by looking at the words before it. In some examples, the decoder(s) 1060 can generate natural language text based on the input sequence and any learned context.

The decoder(s) 1060 can generate embeddings 1066 and feed the embeddings 1066 to one or more network layers 1068. In some examples, the one or more network layers 1068 can include a linear layer and a softmax function. The linear layer can map the embeddings 1066 generated by the decoder(s) 1060 to a higher-dimensional space, which can transform the embeddings 1066 into the original input space. The softmax function can then be applied to generate a probability distribution for each output token in the vocabulary, which can result in an output 1070. In some examples, the output 1070 can include output tokens with probabilities.

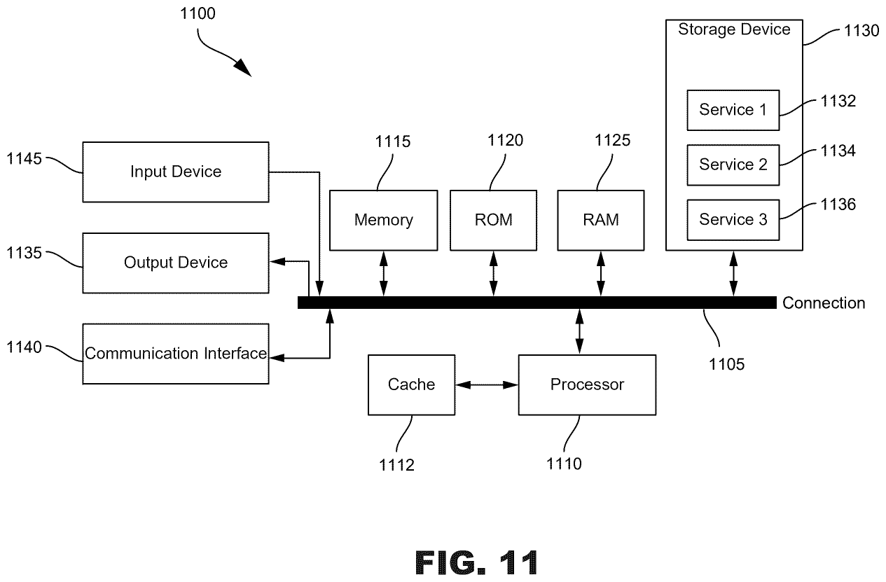

FIG. 11 illustrates an example processor-based system with which some aspects of the subject technology can be implemented. For example, processor-based system 1100 can be any computing device making up the workflow automation platform 210, any of the client devices 116, or any component thereof in which the components of the system are in communication with each other using connection 1105. Connection 1105 can be a physical connection via a bus, or a direct connection into processor 1110, such as in a chipset architecture. Connection 1105 can also be a virtual connection, networked connection, or logical connection.

In some examples, computing system 1100 is a distributed system in which the functions described in this disclosure can be distributed within a datacenter, multiple data centers, a peer network, etc. In some implementations, one or more of the described system components represents many such components each performing some or all of the function for which the component is described. In some embodiments, the components can be physical or virtual devices.

Example system 1100 includes at least one processing unit (Central Processing Unit (CPU) or processor) 1110 and connection 1105 that couples various system components including system memory 1115, such as Read-Only Memory (ROM) 1120 and Random-Access Memory (RAM) 1125 to processor 1110. Computing system 1100 can include a cache of high-speed memory 1112 connected directly with, in close proximity to, or integrated as part of processor 1110.

Processor 1110 can include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms known to those of skill in the art. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 1130 can include software services, servers, services, etc., that when the code that defines such software is executed by the processor 1110, it causes the system 1100 to perform a function. In some embodiments, a hardware service that performs a particular function can include the software component stored in a computer-readable medium in connection with the necessary hardware components, such as processor 1110, connection 1105, output device 1135, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Examples of the present disclosure include:

Aspect 1. A computer-implemented method comprising: receiving an input prompt representing a request to generate a flow in a workflow automation platform, wherein the input prompt includes a description of the flow, and wherein the description of the flow includes a linkage between a metadata tag and a data structure; identifying, based on the linkage, data associated with the flow; determining a set of components of the flow based on the description of the flow and the data associated with the flow, the set of components of the flow comprising a flow trigger and a flow action; and based on the set of components of the flow, generating the flow in the workflow automation platform, the generated flow comprising executable instructions configured to trigger the flow action in response to a detection of the flow trigger.

Aspect 2. The computer-implemented method of Aspect 1, wherein the description of the flow comprises metadata tag, wherein the metadata tag links one or more terms in the metadata tag to the data structure, and wherein the data structure comprises at least one of a database table, a database record, and an instance of an object.

Aspect 3. The computer-implemented method of any of Aspects 1 to 2, wherein the description of the flow comprises a description of the set of components of the flow, and wherein determining the set of components of the flow comprises: based on the data associated with the flow, determining a context associated with at least one of the flow and an entity associated with the workflow automation platform; based on the description of the set of components of the flow, interpreting a meaning of the set of components of the flow with respect to the context associated with at least one of the flow and the entity; and determining the flow trigger and the flow action based on the meaning of the set of components of the flow with respect to the context associated with at least one of the flow and the entity.

Aspect 4. The computer-implemented method of any of Aspects 1 to 3, wherein the metadata tag comprises one or more hashtags, the computer-implemented method further comprising: parsing the input prompt; identifying the one or more hashtags based on the parsing of the input prompt; and based on the one or more hashtags, querying the data structure; and based on querying the data structure, retrieving the data associated with the flow from data structure.

Aspect 5. The computer-implemented method of any of Aspects 1 to 4, wherein the flow action comprises at least one of a conditional action and a repeated action, wherein the set of components of the flow further comprises flow logic, and wherein the flow logic specifies the at least one of the conditional action and the repeated action and one or more conditions associated with the at least one of the conditional action and the repeated action.

Aspect 6. The computer-implemented method of any of Aspects 1 to 5, wherein generating the flow comprises rendering a visual representation of the flow as the flow is generated.

Aspect 7. The computer-implemented method of Aspect 6, wherein the set of components of the flow further comprises one or more conditions associated with the flow action, and wherein rendering the visual representation of the flow as the flow is generated comprises: rendering an outline of the flow, the outline of the flow comprising a first representation of the flow trigger, one or more representations of the one or more conditions associated with the flow action, a second representation of the flow action, and interdependencies associated with the flow trigger, the one or more conditions, and the flow action; adding one or more details of the flow trigger to the first representation of the flow trigger; adding respective details of the one or more conditions to the one or more representations of the one or more conditions; and adding one or more details of the flow action to the second representation of the flow action.

Aspect 8. The computer-implemented method of any of Aspects 1 to 7, further comprising: determining a first set of accuracy scores for a first set of flows created by a first version of an artificial intelligence (AI) model based on a first set of input prompts and determining a second set of accuracy scores for a second set of flows created by a second version of the AI model based on a second set of input prompts, wherein each of the first set of accuracy scores represents an estimated degree of accuracy of a respective flow from the first set of flows, and wherein each of the second set of accuracy scores represents an estimated degree of accuracy of a respective flow from the second set of flows; determining a first performance of the first version of the AI model based on the first set of accuracy scores determined for the first set of flows created by the first version of the AI model; determining a second performance of the second version of the AI model based on the second set of accuracy scores determined for the second set of flows created by the second version of the AI model; and comparing the first performance of the first version of the AI model with the second performance of the second version of the AI model.

Aspect 9. The computer-implemented method of Aspect 8, further comprising: determining whether the respective flow from the first set of flows includes any characteristic classified as at least one of undesirable and anomalous, wherein an accuracy score from the first set of accuracy scores determined for each respective flow from the first set of flows is further based on whether the respective flow from the first set of flows includes any characteristic classified as at least one of undesirable and anomalous; and determining whether the respective flow from the second set of flows includes any characteristic classified as at least one of undesirable and anomalous, wherein the accuracy score from the second set of accuracy scores determined for each respective flow from the second set of flows is further based on whether the respective flow from the second set of flows includes any characteristic classified as at least one of undesirable and anomalous.

Aspect 10. The computer-implemented method of any of Aspects 8 to 9, further comprising: determining a first set of specificity scores for the first set of input prompts used by the first version of the AI model to create the first set of flows and determining a second set of specificity scores for the second set of input prompts used by the second version of the AI model to create the second set of flows, wherein each of the first set of specificity scores and the second set of specificity scores represents an estimated degree of specificity of a respective input prompt from the first set of input prompts and the second set of input prompts; based on the first set of specificity scores and the second set of specificity scores, determining whether to calculate a respective usefulness score for any flows from the first set of flows and the second set of flows, the respective usefulness score measuring at least one of an estimated flow quality and an estimated flow value; and in response to determining to calculate the respective usefulness score for one or more flows from the first set of flows and one or more flows from the second set of flows, calculating the respective usefulness score for the one or more flows from the first set of flows and the one or more flows from the second set of flows, wherein the accuracy score for each of the one or more flows from the first set of flows is determined further based on the respective usefulness score for the one or more flows from the first set of flows, and wherein the accuracy score for each of the one or more flows from the second set of flows is determined further based on the respective usefulness score for the one or more flows from the second set of flows.

Aspect 11. A system comprising: one or more processors; and at least one computer-readable storage medium having stored therein instructions which, when executed by the one or more processors, cause the one or more processors to: receive an input prompt representing a request to generate a flow in a workflow automation platform, wherein the input prompt includes a description of the flow, and wherein the description of the flow includes a linkage between a metadata tag and a data structure; identify, based on the linkage, data associated with the flow; determine a set of components of the flow based on the description of the flow and the data associated with the flow, the set of components of the flow comprising a flow trigger and a flow action; and based on the set of components of the flow, generating the flow in the workflow automation platform, the generated flow comprising executable instructions configured to trigger the flow action in response to a detection of the flow trigger.

Aspect 12. The system of Aspect 11, wherein the description of the flow comprises metadata tag, wherein the metadata tag links one or more terms in the metadata tag to the data structure, and wherein the data structure comprises at least one of a database table, a database record, and an instance of an object.

Aspect 13. The system of any of Aspects 11 to 12, wherein the description of the flow comprises a description of the set of components of the flow, and wherein determining the set of components of the flow comprises: based on the data associated with the flow, determining a context associated with at least one of the flow and an entity associated with the workflow automation platform; based on the description of the set of components of the flow, interpreting a meaning of the set of components of the flow with respect to the context associated with at least one of the flow and the entity; and determining the flow trigger and the flow action based on the meaning of the set of components of the flow with respect to the context associated with at least one of the flow and the entity.

Aspect 14. The system of any of Aspects 11 to 13, wherein the metadata tag comprises one or more hashtags, the computer-implemented method further comprising: parsing the input prompt; identifying the one or more hashtags based on the parsing of the input prompt; and based on the one or more hashtags, querying the data structure; and based on querying the data structure, retrieving the data associated with the flow from data structure.

Aspect 15. The system of any of Aspects 11 to 14, wherein the flow action comprises at least one of a conditional action and a repeated action, wherein the set of components of the flow further comprises flow logic, and wherein the flow logic specifies the at least one of the conditional action and the repeated action and one or more conditions associated with the at least one of the conditional action and the repeated action.

Aspect 16. The system of any of Aspects 11 to 15, wherein generating the flow comprises rendering a visual representation of the flow as the flow is generated, wherein the set of components of the flow further comprises one or more conditions associated with the flow action, and wherein rendering the visual representation of the flow as the flow is generated comprises: rendering an outline of the flow, the outline of the flow comprising a first representation of the flow trigger, one or more representations of the one or more conditions associated with the flow action, a second representation of the flow action, and interdependencies associated with the flow trigger, the one or more conditions, and the flow action; adding one or more details of the flow trigger to the first representation of the flow trigger; adding respective details of the one or more conditions to the one or more representations of the one or more conditions; and adding one or more details of the flow action to the second representation of the flow action.

Aspect 17. The system of any of Aspects 11 to 16, wherein the instructions, when executed by the one or more processors, cause the one or more processors to: determine a first set of accuracy scores for a first set of flows created by a first version of an artificial intelligence (AI) model based on a first set of input prompts and determining a second set of accuracy scores for a second set of flows created by a second version of the AI model based on a second set of input prompts, wherein each of the first set of accuracy scores represents an estimated degree of accuracy of a respective flow from the first set of flows, and wherein each of the second set of accuracy scores represents an estimated degree of accuracy of a respective flow from the second set of flows; determine a first performance of the first version of the AI model based on the first set of accuracy scores determined for the first set of flows created by the first version of the AI model; determine a second performance of the second version of the AI model based on the second set of accuracy scores determined for the second set of flows created by the second version of the AI model; and compare the first performance of the first version of the AI model with the second performance of the second version of the AI model.

Aspect 18. The system of Aspect 17, wherein the instructions, when executed by the one or more processors, cause the one or more processors to: determine whether the respective flow from the first set of flows includes any characteristic classified as at least one of undesirable and anomalous, wherein an accuracy score from the first set of accuracy scores determined for each respective flow from the first set of flows is further based on whether the respective flow from the first set of flows includes any characteristic classified as at least one of undesirable and anomalous; and determine whether the respective flow from the second set of flows includes any characteristic classified as at least one of undesirable and anomalous, wherein the accuracy score from the second set of accuracy scores determined for each respective flow from the second set of flows is further based on whether the respective flow from the second set of flows includes any characteristic classified as at least one of undesirable and anomalous.

Aspect 19. The system of any of Aspects 17 to 18, wherein the instructions, when executed by the one or more processors, cause the one or more processors to: determine a first set of specificity scores for the first set of input prompts used by the first version of the AI model to create the first set of flows and determining a second set of specificity scores for the second set of input prompts used by the second version of the AI model to create the second set of flows, wherein each of the first set of specificity scores and the second set of specificity scores represents an estimated degree of specificity of a respective input prompt from the first set of input prompts and the second set of input prompts; based on the first set of specificity scores and the second set of specificity scores, determine whether to calculate a respective usefulness score for any flows from the first set of flows and the second set of flows, the respective usefulness score measuring at least one of an estimated flow quality and an estimated flow value; and in response to determining to calculate the respective usefulness score for one or more flows from the first set of flows and one or more flows from the second set of flows, calculate the respective usefulness score for the one or more flows from the first set of flows and the one or more flows from the second set of flows, wherein the accuracy score for each of the one or more flows from the first set of flows is determined further based on the respective usefulness score for the one or more flows from the first set of flows, and wherein the accuracy score for each of the one or more flows from the second set of flows is determined further based on the respective usefulness score for the one or more flows from the second set of flows.

Aspect 20. A non-transitory computer-readable medium having stored thereon instructions which, when executed by one or more processors, cause the one or more processors to: receive an input prompt representing a request to generate a flow in a workflow automation platform, wherein the input prompt includes a description of the flow, and wherein the description of the flow includes a linkage between a metadata tag and a data structure; identify, based on the linkage, data associated with the flow; determine a set of components of the flow based on the description of the flow and the data associated with the flow, the set of components of the flow comprising a flow trigger and a flow action; and based on the set of components of the flow, generating the flow in the workflow automation platform, the generated flow comprising executable instructions configured to trigger the flow action in response to a detection of the flow trigger.

Aspect 21. A system comprising means for performing a method according to any of Aspects 1 to 10.

Aspect 22. A computer-program product having stored thereon instructions which, when executed by one or more processors, cause the one or more processors to perform a method according to any of Aspects 1 to 10.

What is claimed is:

1. A computer-implemented method comprising:
receiving an input prompt representing a request to generate a flow in a workflow automation platform, wherein the input prompt includes a description of the flow, and wherein the description of the flow includes a linkage between a metadata tag and a data structure;
identifying, based on the linkage, data associated with the flow;
determining a set of components of the flow based on the description of the flow and the data associated with the flow, the set of components of the flow comprising a flow trigger and a flow action; and
based on the set of components of the flow, generating the flow in the workflow automation platform, the generated flow comprising executable instructions configured to trigger the flow action in response to a detection of the flow trigger.

2. The computer-implemented method of claim 1, wherein the description of the flow comprises metadata tag, wherein the metadata tag links one or more terms in the metadata tag to the data structure, and wherein the data structure comprises at least one of a database table, a database record, and an instance of an object.

3. The computer-implemented method of claim 1, wherein the description of the flow comprises a description of the set of components of the flow, and wherein determining the set of components of the flow comprises:
based on the data associated with the flow, determining a context associated with at least one of the flow and an entity associated with the workflow automation platform;
based on the description of the set of components of the flow, interpreting a meaning of the set of components of the flow with respect to the context associated with at least one of the flow and the entity; and
determining the flow trigger and the flow action based on the meaning of the set of components of the flow with respect to the context associated with at least one of the flow and the entity.

4. The computer-implemented method of claim 1, wherein the metadata tag comprises one or more hashtags, the computer-implemented method further comprising:
parsing the input prompt;
identifying the one or more hashtags based on the parsing of the input prompt; and
based on the one or more hashtags, querying the data structure; and
based on querying the data structure, retrieving the data associated with the flow from data structure.

5. The computer-implemented method of claim 1, wherein the flow action comprises at least one of a conditional action and a repeated action, wherein the set of components of the flow further comprises flow logic, and wherein the flow logic specifies the at least one of the conditional action and the repeated action and one or more conditions associated with the at least one of the conditional action and the repeated action.

6. The computer-implemented method of claim 1, wherein generating the flow comprises rendering a visual representation of the flow as the flow is generated.

7. The computer-implemented method of claim 6, wherein the set of components of the flow further comprises one or more conditions associated with the flow action, and wherein rendering the visual representation of the flow as the flow is generated comprises:
rendering an outline of the flow, the outline of the flow comprising a first representation of the flow trigger, one or more representations of the one or more conditions associated with the flow action, a second representation of the flow action, and interdependencies associated with the flow trigger, the one or more conditions, and the flow action;
adding one or more details of the flow trigger to the first representation of the flow trigger;
adding respective details of the one or more conditions to the one or more representations of the one or more conditions; and
adding one or more details of the flow action to the second representation of the flow action.

8. The computer-implemented method of claim 1, further comprising:
determining a first set of accuracy scores for a first set of flows created by a first version of an artificial intelligence (AI) model based on a first set of input prompts and determining a second set of accuracy scores for a second set of flows created by a second version of the AI model based on a second set of input prompts, wherein each of the first set of accuracy scores represents an estimated degree of accuracy of a respective flow from the first set of flows, and wherein each of the second set of accuracy scores represents an estimated degree of accuracy of a respective flow from the second set of flows;
determining a first performance of the first version of the AI model based on the first set of accuracy scores determined for the first set of flows created by the first version of the AI model;
determining a second performance of the second version of the AI model based on the second set of accuracy scores determined for the second set of flows created by the second version of the AI model; and
comparing the first performance of the first version of the AI model with the second performance of the second version of the AI model.

9. The computer-implemented method of claim 8, further comprising:
determining whether the respective flow from the first set of flows includes any characteristic classified as at least one of undesirable and anomalous, wherein an accuracy score from the first set of accuracy scores determined for each respective flow from the first set of flows is further based on whether the respective flow from the first set of flows includes any characteristic classified as at least one of undesirable and anomalous; and
determining whether the respective flow from the second set of flows includes any characteristic classified as at least one of undesirable and anomalous, wherein the accuracy score from the second set of accuracy scores determined for each respective flow from the second set of flows is further based on whether the respective flow from the second set of flows includes any characteristic classified as at least one of undesirable and anomalous.

10. The computer-implemented method of claim 8, further comprising:
determining a first set of specificity scores for the first set of input prompts used by the first version of the AI model to create the first set of flows and determining a second set of specificity scores for the second set of input prompts used by the second version of the AI model to create the second set of flows, wherein each of the first set of specificity scores and the second set of specificity scores represents an estimated degree of specificity of a respective input prompt from the first set of input prompts and the second set of input prompts;
based on the first set of specificity scores and the second set of specificity scores, determining whether to calculate a respective usefulness score for any flows from the first set of flows and the second set of flows, the respective usefulness score measuring at least one of an estimated flow quality and an estimated flow value; and
in response to determining to calculate the respective usefulness score for one or more flows from the first set of flows and one or more flows from the second set of flows, calculating the respective usefulness score for the one or more flows from the first set of flows and the one or more flows from the second set of flows, wherein the accuracy score for each of the one or more flows from the first set of flows is determined further based on the respective usefulness score for the one or more flows from the first set of flows, and wherein the accuracy score for each of the one or more flows from the second set of flows is determined further based on the respective usefulness score for the one or more flows from the second set of flows.

11. A system comprising:
one or more processors; and
at least one computer-readable storage medium having stored therein instructions which, when executed by the one or more processors, cause the one or more processors to:
receive an input prompt representing a request to generate a flow in a workflow automation platform, wherein the input prompt includes a description of the flow, and wherein the description of the flow includes a linkage between a metadata tag and a data structure;
identify, based on the linkage, data associated with the flow;
determine a set of components of the flow based on the description of the flow and the data associated with the flow, the set of components of the flow comprising a flow trigger and a flow action; and
based on the set of components of the flow, generating the flow in the workflow automation platform, the generated flow comprising executable instructions configured to trigger the flow action in response to a detection of the flow trigger.

12. The system of claim 11, wherein the description of the flow comprises metadata tag, wherein the metadata tag links one or more terms in the metadata tag to the data structure, and wherein the data structure comprises at least one of a database table, a database record, and an instance of an object.

13. The system of claim 11, wherein the description of the flow comprises a description of the set of components of the flow, and wherein determining the set of components of the flow comprises:
based on the data associated with the flow, determining a context associated with at least one of the flow and an entity associated with the workflow automation platform;
based on the description of the set of components of the flow, interpreting a meaning of the set of components of the flow with respect to the context associated with at least one of the flow and the entity; and
determining the flow trigger and the flow action based on the meaning of the set of components of the flow with respect to the context associated with at least one of the flow and the entity.

14. The system of claim 11, wherein the metadata tag comprises one or more hashtags, the computer-implemented method further comprising:
parsing the input prompt;
identifying the one or more hashtags based on the parsing of the input prompt; and
based on the one or more hashtags, querying the data structure; and
based on querying the data structure, retrieving the data associated with the flow from data structure.

15. The system of claim 11, wherein the flow action comprises at least one of a conditional action and a repeated action, wherein the set of components of the flow further comprises flow logic, and wherein the flow logic specifies the at least one of the conditional action and the repeated action and one or more conditions associated with the at least one of the conditional action and the repeated action.

16. The system of claim 11, wherein generating the flow comprises rendering a visual representation of the flow as the flow is generated, wherein the set of components of the flow further comprises one or more conditions associated with the flow action, and wherein rendering the visual representation of the flow as the flow is generated comprises:
rendering an outline of the flow, the outline of the flow comprising a first representation of the flow trigger, one or more representations of the one or more conditions associated with the flow action, a second representation of the flow action, and interdependencies associated with the flow trigger, the one or more conditions, and the flow action;
adding one or more details of the flow trigger to the first representation of the flow trigger;
adding respective details of the one or more conditions to the one or more representations of the one or more conditions; and
adding one or more details of the flow action to the second representation of the flow action.

17. The system of claim 11, wherein the instructions, when executed by the one or more processors, cause the one or more processors to:
determine a first set of accuracy scores for a first set of flows created by a first version of an artificial intelligence (AI) model based on a first set of input prompts and determining a second set of accuracy scores for a second set of flows created by a second version of the AI model based on a second set of input prompts, wherein each of the first set of accuracy scores represents an estimated degree of accuracy of a respective flow from the first set of flows, and wherein each of the second set of accuracy scores represents an estimated degree of accuracy of a respective flow from the second set of flows;
determine a first performance of the first version of the AI model based on the first set of accuracy scores determined for the first set of flows created by the first version of the AI model;
determine a second performance of the second version of the AI model based on the second set of accuracy scores determined for the second set of flows created by the second version of the AI model; and
compare the first performance of the first version of the AI model with the second performance of the second version of the AI model.

18. The system of claim 17, wherein the instructions, when executed by the one or more processors, cause the one or more processors to:
determine whether the respective flow from the first set of flows includes any characteristic classified as at least one of undesirable and anomalous, wherein an accuracy score from the first set of accuracy scores determined for each respective flow from the first set of flows is further based on whether the respective flow from the first set of flows includes any characteristic classified as at least one of undesirable and anomalous; and
determine whether the respective flow from the second set of flows includes any characteristic classified as at least one of undesirable and anomalous, wherein the accuracy score from the second set of accuracy scores determined for each respective flow from the second set of flows is further based on whether the respective flow from the second set of flows includes any characteristic classified as at least one of undesirable and anomalous.

19. The system of claim 17, wherein the instructions, when executed by the one or more processors, cause the one or more processors to:
determine a first set of specificity scores for the first set of input prompts used by the first version of the AI model to create the first set of flows and determining a second set of specificity scores for the second set of input prompts used by the second version of the AI model to create the second set of flows, wherein each of the first set of specificity scores and the second set of specificity scores represents an estimated degree of specificity of a respective input prompt from the first set of input prompts and the second set of input prompts;
based on the first set of specificity scores and the second set of specificity scores, determine whether to calculate a respective usefulness score for any flows from the first set of flows and the second set of flows, the respective usefulness score measuring at least one of an estimated flow quality and an estimated flow value; and
in response to determining to calculate the respective usefulness score for one or more flows from the first set of flows and one or more flows from the second set of flows, calculate the respective usefulness score for the one or more flows from the first set of flows and the one or more flows from the second set of flows, wherein the accuracy score for each of the one or more flows from the first set of flows is determined further based on the respective usefulness score for the one or more flows from the first set of flows, and wherein the accuracy score for each of the one or more flows from the second set of flows is determined further based on the respective usefulness score for the one or more flows from the second set of flows.

20. A non-transitory computer-readable medium having stored thereon instructions which, when executed by one or more processors, cause the one or more processors to:
receive an input prompt representing a request to generate a flow in a workflow automation platform, wherein the input prompt includes a description of the flow, and wherein the description of the flow includes a linkage between a metadata tag and a data structure;
identify, based on the linkage, data associated with the flow;
determine a set of components of the flow based on the description of the flow and the data associated with the flow, the set of components of the flow comprising a flow trigger and a flow action; and
based on the set of components of the flow, generating the flow in the workflow automation platform, the generated flow comprising executable instructions configured to trigger the flow action in response to a detection of the flow trigger.
